(19) United States
(12) Patent Application Publication
(10) Pub. No.: US 2006/0114681 A1
(43) Pub. Date: Jun. 1, 2006

(54) Retractable and adjustable multi-purpose indoor lighting fixture

(76) Inventor: Junli Wang, Chicago, IL (US)

Correspondence Address: Junli Wang, Ste. 900, 188 W. Randolph St., Chicago, IL, 60601, US

(21) Appl. No.: 11/000,758

(22) Filed: Dec. 1, 2004

(51) Int. Cl. F21S 8/08; F21V 19/02

(52) U.S. Cl. 362/418; 362/449; 362/285

(57) ABSTRACT

This invention concerns a retractable and adjustable multi-purpose indoor lighting fixture that is capable of be adjusted to be either a reading light, or a study light, or working light, or a wall sconce light, or wall wash light. This indoor lighting fixture can be used outdoor as well, as long as the light for such lighting fixture is powerful enough to meet the outdoor requirement and water proof. This lighting fixture can be controlled either by hand or through a remote control. The remote control can be activated by either voice or light wave or other means.

### BACKGROUND OF THE INVENTION

1. Field of the Invention

The present invention relates to lighting fixtures that are widely used in the daily life. More specifically, my invention is primarily relates to a retractable and adjustable multi-purpose indoor lighting fixture that can be used either as a study light, or reading light, or a working light, or a displaying light, or picture light, or a wall sconce/wall wash light, or alike to light various intended areas by adjusting the position of the lighting fixture and the direction of the light. The current invention is capable of providing both ambient surrounding room light and direct illumination for a specific surface area.

2. Description of the Prior Art

A wide variety of lighting fixtures are available today in the related art for providing the lighting needs of daily life. Basically, the indoor lighting fixtures are divided into two major types based on their functions, one of which is to provide ambient or surrounding room lighting, the other of which is to provide direct illumination for a specific area.

Lighting fixtures which provide ambient indoor lighting include a wide variety of overhead lighting fixtures, wall mounted lighting fixtures, and floor-standing lighting fixtures. The light sources for these lighting fixtures include fluorescent bulbs, incandescent bulbs and high intensive discharge bulbs. Those lighting fixtures which provide direct work surface illumination come in a wide variety of styles and shapes as well. The light sources for these lighting fixtures include filament lamps and fluorescent tubes as well halogen bulbs. While existing direct surface illumination devices are generally satisfactory for providing adequate light and may even employ a visually appealing support structure, the use of these lighting fixtures usually takes relatively large space on the work surface.

The conventional lighting fixtures capable of providing ambient surrounding room lighting are usually fixtures on the ceiling or wall, or those standing on the floor. These lighting fixtures usually provide enough light for a massive area. However, none of which has exact the light for comfortable reading. The conventional lighting fixtures capable of illumination for a specific area are mainly table lamps, desk lamps, work lamps. These lighting fixtures usually provide comfortable lighting illumination for a specific area. However, none of which could provide enough ambient surrounding room lighting.

Currently, most of the bedrooms in the United States are lighted by either wall sconce, or ceiling light, or lights standing on the floor. Those lights are capable of providing enough ambient surrounding room light, however, not comfortable enough for the reading or specific working needs. There is no such an indoor lighting fixture that can work as both a direct work surface illumination lighting fixture, and an ambient surrounding lighting fixture.

What is needed then is a retractable and adjustable multi-purpose indoor lighting fixture that can be used as both a kind of indoor lighting fixture capable of providing ambient or surrounding room lighting, and a kind of indoor lighting fixture capable of providing direct illumination for a specific surface area when needed.

Accordingly, it is a principal objective of my invention to provide a retractable and adjustable multi-purpose indoor lighting fixture that can be employed as both an ambient room lighting fixture and a direct surface lighting fixture.

It is a further objective of my invention to provide a retractable and adjustable multi-purpose indoor lighting fixture that can be employed as both an ambient room lighting fixture when folded, and a direct surface illumination lighting fixture when extended;

It is a still further objective of my invention to provide a retractable and adjustable multi-purpose indoor lighting fixture that can be employed as both an ambient room lighting fixture, and a direct surface illumination lighting fixture;

It is a still further objective of my invention to provide a retractable and adjustable multi-purpose indoor lighting fixture that can be installed as a wall sconce/wall wash light, and be used as a reading light, working light, picture light or displaying light.

It is a still further objective of my invention to provide a retractable and adjustable multi-purpose indoor lighting fixture that can be installed as a ceiling light, and be used as a reading light.

It is a still further objective of my invention to provide a retractable and adjustable multi-purpose indoor lighting fixture that can be installed as a stand along working light, and be used as a reading light.

It is a still further objective of my invention to provide a retractable and adjustable multi-purpose indoor lighting fixture that can be installed as a ambient room light, and be used as a direct illumination light.

Other objects of my invention, as well as particular features, elements, and advantages thereof, will be elucidated in, or apparent from, the following description and the accompanying drawing figures.

### SUMMARY OF THE INVENTION

According to my present invention, I have provided a retractable and adjustable multi-purpose indoor lighting fixture capable of providing both ambient or surrounding room lighting and direct illumination for a specific surface area.

The present invention provides a retractable and adjustable multi-purpose indoor lighting fixture capable of providing both ambient surrounding room light and direct illumination for a specific surface area, said lighting fixture comprises a light bulb housing, said light bulb housing further comprising a back light bulb housing cover, a glass front light bulb housing cover, a socket, said socket connected to said light bulb housing, a light bulb, said light bulb connected to said socket and positioned between said back light bulb housing cover and said glass front light bulb housing cover, a reflector, said reflector connected to said light bulb housing and positioned between said back light bulb housing cover and said light bulb; a pivot connector, said pivot connector having a first pivot end and a second pivot end, said first pivot end connected to said light bulb housing; a retractable arm box, said retractable arm box connected to said second pivot end; a retractable arm set, said retractable arm set having a first retractable arm end and a second retractable arm end, said first retractable arm end connected to said retractable arm box; a mounting base, said mounting base having a first mounting base end and a second mounting base end, said first mounting base end connected to said second retractable arm end, and said second mounting base end mounted onto a wall; and an electrical line, said electrical line having a first electrical line end and a second electrical line end, said first electrical line end connected to said light bulb, said second electrical line end connected to an electric power source.

The present invention also provides a method for the use of a retractable and adjustable multi-purpose indoor lighting fixture capable of providing both ambient surrounding room light and direct illumination for a specific surface area.

### DESCRIPTION OF THE DRAWINGS

Other features of my invention will become more evident from a consideration of the following detailed description of my patent drawings, as follows:

FIG. 1 is a three dimensional view of the first preferred embodiment of current invention with one light bulb housing, one retractable arm box and one mounting base;

FIG. 2 is an explosive view of the first preferred embodiment of the current invention with one light bulb housing, one retractable arm box and one mounting base;

FIG. 3 is a front view of the first preferred embodiment of the current invention with one light bulb housing, one retractable arm box and one mounting base;

FIG. 4 is a top view of the first preferred embodiment of the current invention with one light bulb housing, one retractable arm box and one mounting base;

FIG. 5 is a sectional side view of the first preferred embodiment of the current invention with one light bulb housing, one retractable arm box and one mounting base;

FIG. 6 is a three dimensional view of the first preferred embodiment of the current invention with one light bulb housing, one retractable arm box and one mounting base, with retractable arm extending out from the retractable arm box;

FIG. 7 is a three dimensional view of the second preferred embodiment of the current invention with three light bulb housing, one retractable arm box and one mounting base;

FIG. 8 is an explosive view of the second preferred embodiment of the current invention with three light bulb housing, one retractable arm box and one mounting base;

FIG. 9 is a front view of the second preferred embodiment of the current invention with three light bulb housing, one retractable arm box and one mounting base;

FIG. 10 is a top view of the second preferred embodiment of the current invention with three light bulb housing, one retractable arm box and one mounting base;

FIG. 11 is a side view of the second preferred embodiment of the current invention with three light bulb housing, one retractable arm box and one mounting base;

FIG. 12 is a three dimensional view of the second preferred embodiment of the current invention with three light bulb housing, one retractable arm box and one mounting base, with retractable arm extending out from the retractable arm box;

FIG. 13 is a three dimensional view of the third preferred embodiment of the current invention with three light bulb housing, three retractable arm box and one mounting base;

FIG. 14 is a top view of the third preferred embodiment of the current invention with three light bulb housing, three retractable arm box and one mounting base;

FIG. 15 is a front view of the third preferred embodiment of the current invention with three light bulb housing, three retractable arm box and one mounting base;

FIG. 16 is a three dimensional view of the third preferred embodiment of the current invention with three light bulb housing, three retractable arm box and one mounting base, with retractable arms extending out from one of the retractable arm boxes;

FIG. 17 is a three dimensional view of the fourth preferred embodiment of the current invention with two light bulb housings, one light bulb housing arm, one folded arm and one mounting base;

FIG. 18 is an explosive view of the fourth preferred embodiment of the current invention with two light bulb housings, one light bulb housing arm, one folded arm and one mounting base;

FIG. 19 is a side view of the fourth preferred embodiment of the current invention with two light bulb housings, one light bulb housing arm, one folded arm and one mounting base;

FIG. 20 is a front view of the fourth preferred embodiment of the current invention with two light bulb housings, one light bulb housing arm, one folded arm and one mounting base;

FIG. 21 is a three dimensional view of the fourth preferred embodiment of the current invention with two light bulb housings, one light bulb housing arm, one folded arm and one mounting base, with folded arm unfolded;

FIG. 22 is a three dimensional view of the fifth preferred embodiment of the current invention with two light bulb housings, one retractable arm and one mounting base;

FIG. 23 is an explosive view of the fifth preferred embodiment of the current invention with two light bulb housings, one retractable arm and one mounting base;

FIG. 24(a) is a side view of the fifth preferred embodiment of the current invention with two light bulb housings, one retractable arm and one mounting base;

FIG. 24(b) is a front view of the fifth preferred embodiment of the current invention with two light bulb housings, one retractable arm and one mounting base;

FIG. 25 is a three dimensional view of the fifth preferred embodiment of the current invention with two light bulb housings, one retractable arm and one mounting base, with retractable arm extending out;

FIG. 26 is a three dimensional view of the sixth preferred embodiment of the current invention with one light bulb housing, one retractable arm box and one mounting base;

FIG. 27 is a three dimensional view of the sixth preferred embodiment of the current invention with one light bulb housing, one retractable arm box and one mounting base, with retractable arm extending out from the retractable arm box;

FIG. 28 is a three dimensional view of the seventh preferred embodiment of the current invention with one light bulb housing, one retractable arm box and one mounting base, attached to a stand along lighting fixture;

FIG. 29 is a three dimensional view of the seventh preferred embodiment of the current invention with one light bulb housing, one retractable arm box and one mounting base, with folded arm unfolded and extended from a stand along lighting fixture; and

FIG. 30 is a partially explosive view of the seventh preferred embodiment of the current invention with one light bulb housing, one retractable arm box and one mounting base, attached to a stand along lighting fixture.

### DETAILED DESCRIPTION OF THE PREFERRED EMBODIMENT

Referring now to the drawings, my invention concerns a retractable and adjustable multi-purpose indoor lighting fixture capable of providing both ambient surrounding room light and direct illumination for a specific surface area.

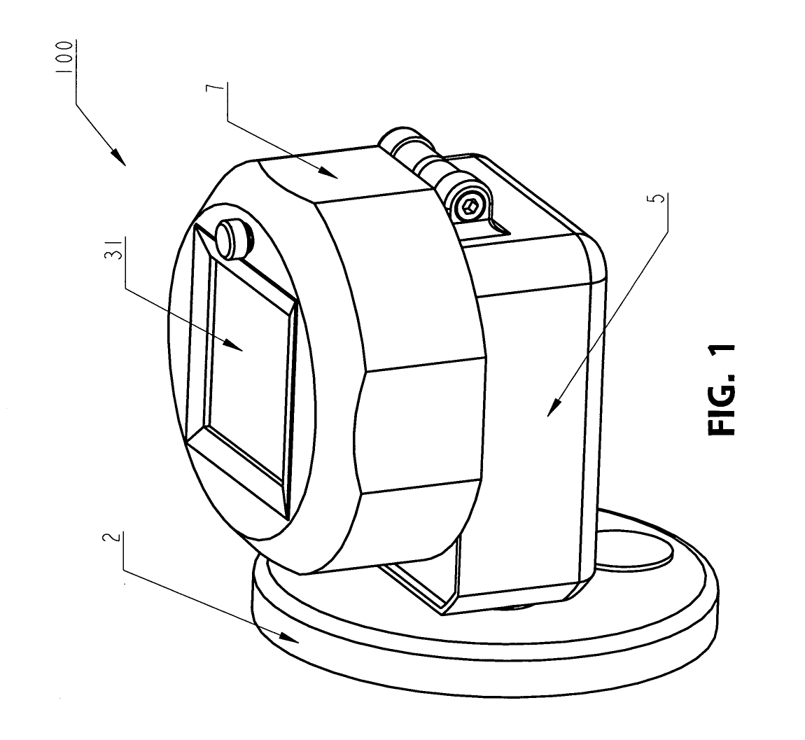

Referring now to FIG. 1, which is a three dimensional view of the first preferred embodiment 100 of the current invention with one light bulb housing 7, one retractable arm box 5, and one mounting base 2. FIG. 1 presents the first preferred embodiment 100 of the current invention at a first position, which enables the first preferred embodiment 100 to be an ambient surrounding room light. When the first preferred embodiment 100 is on, the light comes out upwards from a glass front light bulb housing cover 31.

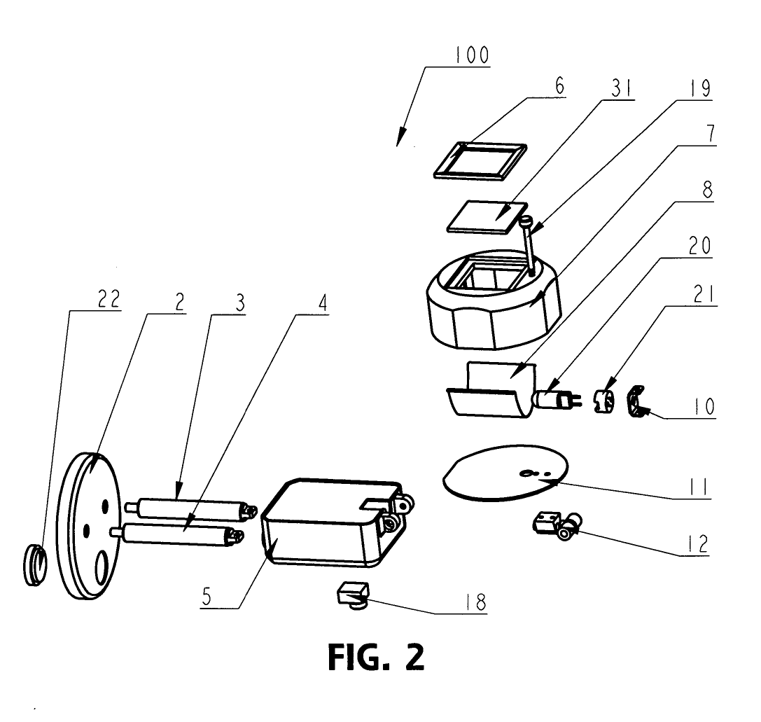

Referring now to FIG. 2, which is an explosive view of the first preferred embodiment 100 of current invention with one light bulb housing 7, one retractable arm box 5, and one mounting base 2. Said lighting fixture 100 comprises a light bulb housing 7, a pivot connector 12, a retractable arm box 5, and a mounting base 2. Said light bulb housing 7 further comprises a back light bulb housing cover 11, a glass front light bulb housing cover 31, a socket 21, said socket 21 connected to said light bulb housing 7 through a socket bracket 10 and bulb adjust screw 19, a light bulb 20, said light bulb 20 connected to said socket 21 and positioned between said back light bulb housing cover 11 and said glass front light bulb housing cover 31, a reflector 8, said reflector 8 connected to said light bulb housing 7 and positioned between said back light bulb housing cover 11 and said light bulb 20. Said pivot connector 12 connects said light bulb housing 7 to said retractable arm box 5. Said retractable arm box 5 has a first retractable arm 3 and a second retractable arm 4. Both said first retractable arm 3 and said second retractable arm 4 are disposed within said retractable arm box 5, and capable of extending out through the wall of said retractable arm box 5. One end of both said first retractable arm 3 and said second retractable arm 4 are mounted onto said mounting base 2. The light bulb 20 is connected to an electric power source through an electrical line and a switch 18. There could be a transformer placed between the light bulb 20 and the electrical power source.

Said glass front light bulb housing cover 31 of said lighting fixture 100 can be at an open position or a closed position. Said socket 21 of said lighting fixture 100 can be a plurality of sockets, each of which has a light bulb 20. The position of said light bulb 20 could be adjusted in order to change light beam angle to meet the intended ambient surrounding room light and direct illumination for specific surface area light. The position of said reflector 8 relative to said light bulb 20 can also be adjusted in order to change light beam angle to meet the intended ambient surrounding room light and direct illumination for specific surface area light. Said lighting fixture 100 has a switch 18, which is capable of controlling volume of electricity flowing through said light bulb 20 in order to control the output of luminance to meet intended requirement of ambient surrounding room light and direct illumination for specific surface area. The first preferred embodiment 100 of the current invention could be employed to provide both ambient surrounding room light and direct illumination for a specific surface area, most of which would be for reading or working or picture or display light. The capability of adjusting the volume of electricity flow through said light bulb 20 is very important in order to enable the current invention to provide light that meets the intended purpose.

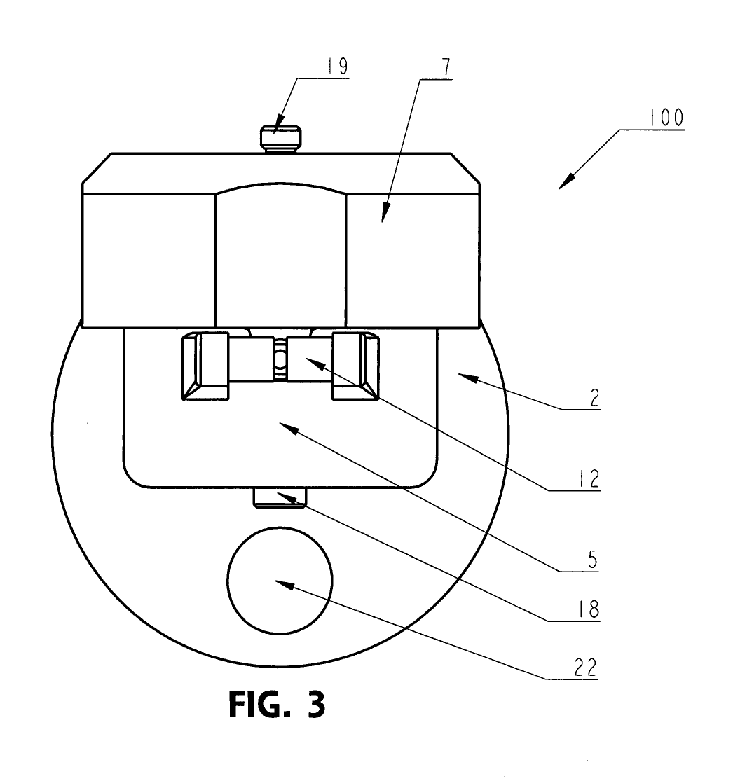

Referring now to FIGS. 2 and 3. FIG. 3 is a front view of the first preferred embodiment 100 of the current invention with one light bulb housing 7, one retractable arm box 5, and one mounting base 2. On top of the light bulb housing 7, there is a bulb adjust screw 19, which is capable of adjusting the position of the light bulb 20 and light bulb socket 21. By adjusting said bulb adjust screw 19, the position of the light bulb 20 will change accordingly relative to said reflector 8. Said light bulb housing 7 is connected to said retractable arm box 5 through said pivot connector 12, and capable of turning around the pivot connector 12 either flip up and down, or turn left and right. There is a switch 18 on said retractable arm box 5. Said retractable arm box 5 is mounted onto said mounting base 2. There is an alarm clock 22 mounted onto said mounting base 2. While the alarm is in active, the electricity flowing through the light bulb 20 could be controlled by said switch 18, and gradually increased from zero to full extend.

The first embodiment 100 of the current invention could be controlled by a remote control. The remote control could be programmed to control the position of said bulb adjust screw 19, said switch 18, the position of said light bulb housing 7 relative to said retractable arm box 5, and the position of said retractable arm box 5 relative to said mounting base 2.

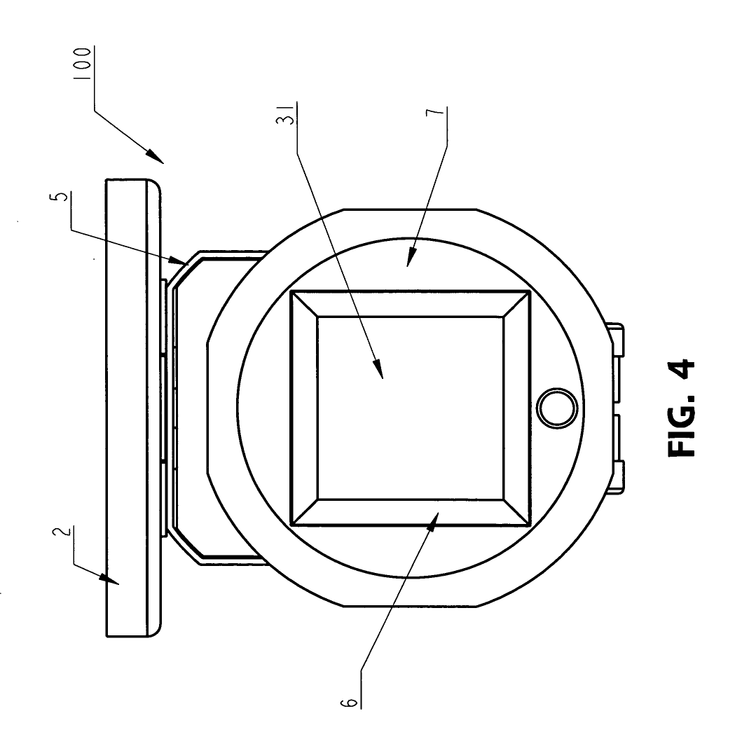

Referring now to FIG. 4, which is a top view of the first preferred embodiment 100 of the current invention with one light bulb housing 7, one retractable arm box 5 and one mounting base 2. Said glass front lighting housing cover 31 is mounted onto said light bulb housing 7 through a glass mounting frame 6.

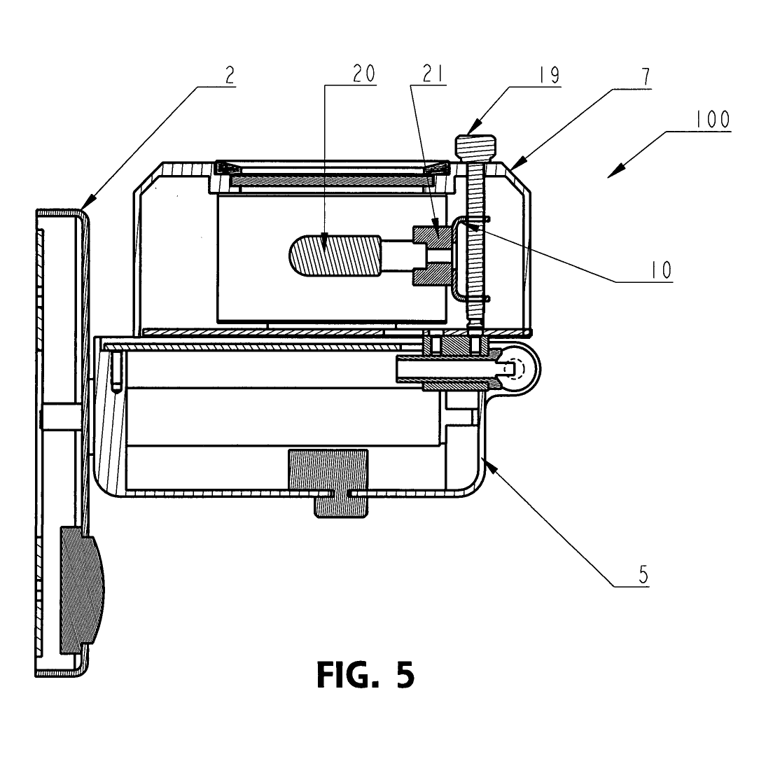

Referring now to FIG. 5, which is a sectional side view of the first preferred embodiment 100 of the current invention with one light bulb housing 7, one retractable arm box 5 and one mounting base 2. A light bulb 20 is disposed within light bulb socket 21. Said light bulb socket 21 is connected to said bulb adjust screw 19 through a socket bracket 10. The light beam angle of said light bulb 20 can be adjusted through said adjust screw 19.

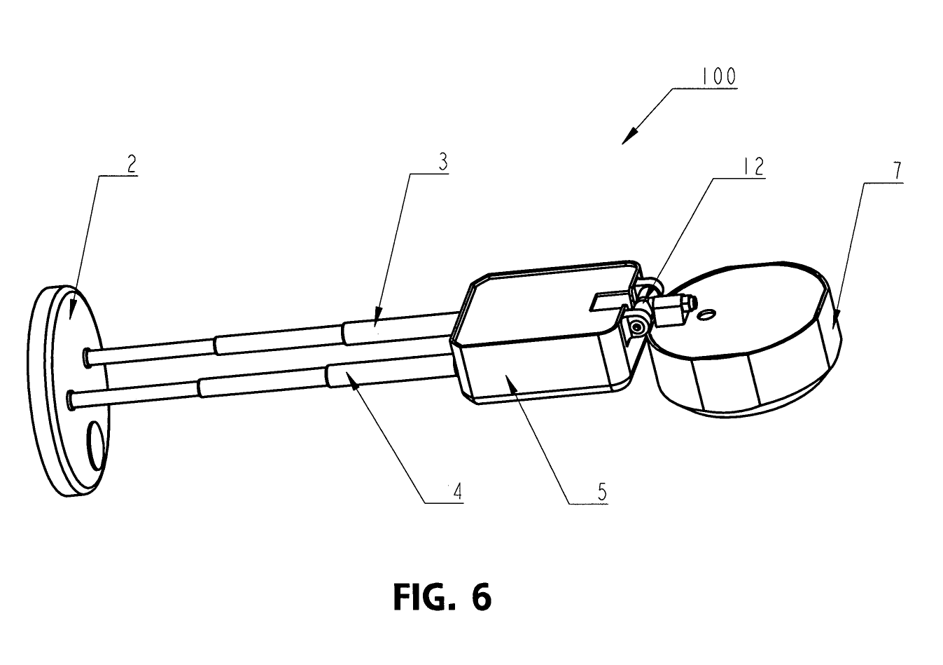

Referring now to FIG. 6, which is a three dimensional view of the first preferred embodiment 100 of the current invention with one light bulb housing 7, one retractable arm box 5 and one mounting base 2. Said retractable arm box 5 is capable of extending away from said mounting base 2, when both said first retractable arm 3 and said second retractable arm 4 are extended out. Said light bulb housing 7 is capable of flip down from its original up position showing in FIGS. 1 through 5 around said pivot connector 12 to any preferred position either flipping up and down, or turning left and right. While the first preferred embodiment 100 of the current invention was positioned as shown in FIGS. 1 through 5, it is intended to provide ambient surrounding room light as either a wall sconce/wall wash light or a ceiling light. While the first preferred embodiment 100 of the current invention was positioned as shown in FIG. 6, it is intended to provide a direct illumination for a specific surface area as either a reading light or working light or picture light or display light. It is very importation to enable the first preferred embodiment 100 of the current invention to be able to position at different positions. Said first retractable arm 3 and said second retractable arm 4 enables the first preferred embodiment 100 to position said light bulb housing 7 far away from said mounting base 2, most of which would be mounted onto a wall. The pivot connector 12 of said first preferred embodiment 100 of the current invention enables said light bulb housing 7 either flipping up and down, or turning left and right. Said first retractable arm 3 and said second retractable arm 4 and said pivot connector 12 enables the first preferred embodiment 100 of the current invention to convert from a lighting fixture capable of providing ambient surrounding room light to a lighting fixture capable of providing direct illumination for a specific surface area.

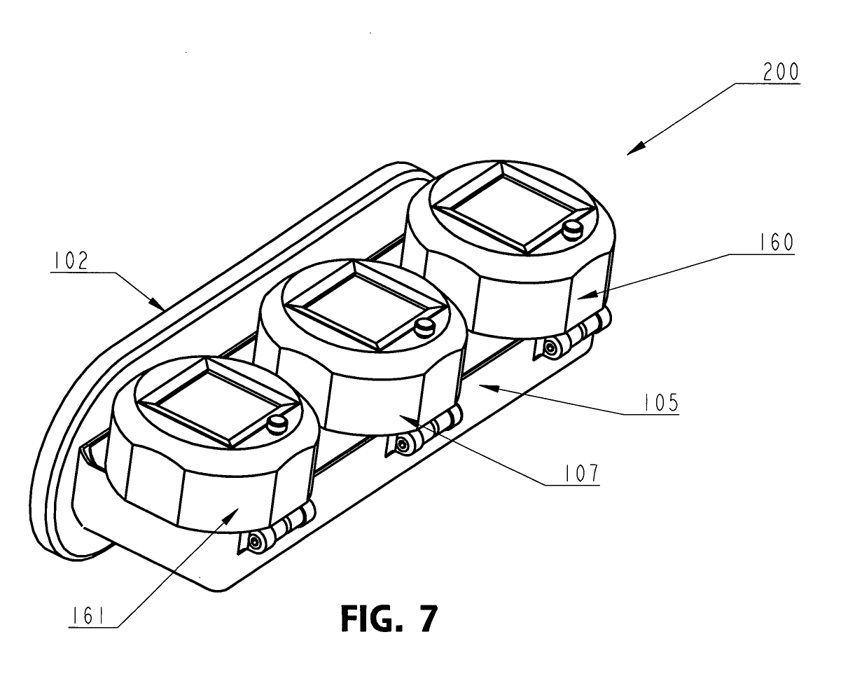

Referring now to FIG. 7, which is a three dimensional view of the second preferred embodiment 200 of current invention with a first light bulb housing 160, a second light bulb housing 107, a third light bulb housing 161, one retractable arm box 105, and one mounting base 102. The second preferred embodiment 200 can employed as either an ambient surrounding light or a direct illumination for a specific surface area or both at the same time. FIG. 7 presents said second preferred embodiment 200 at a first position that is capable of providing ambient surrounding room light. Each of a first light bulb housing 160, a second light bulb housing 107 and a third light bulb housing 161, could be flip down to a second position to provide a direct illumination for a specific surface area, respectively. The combination of the first light bulb housing 160, the second light bulb housing 107 and the third light bulb housing 161 at either a first position or second position enables the second preferred embodiment 200 to provide either ambient surrounding room light, or direct illumination for a specific surface area, or both.

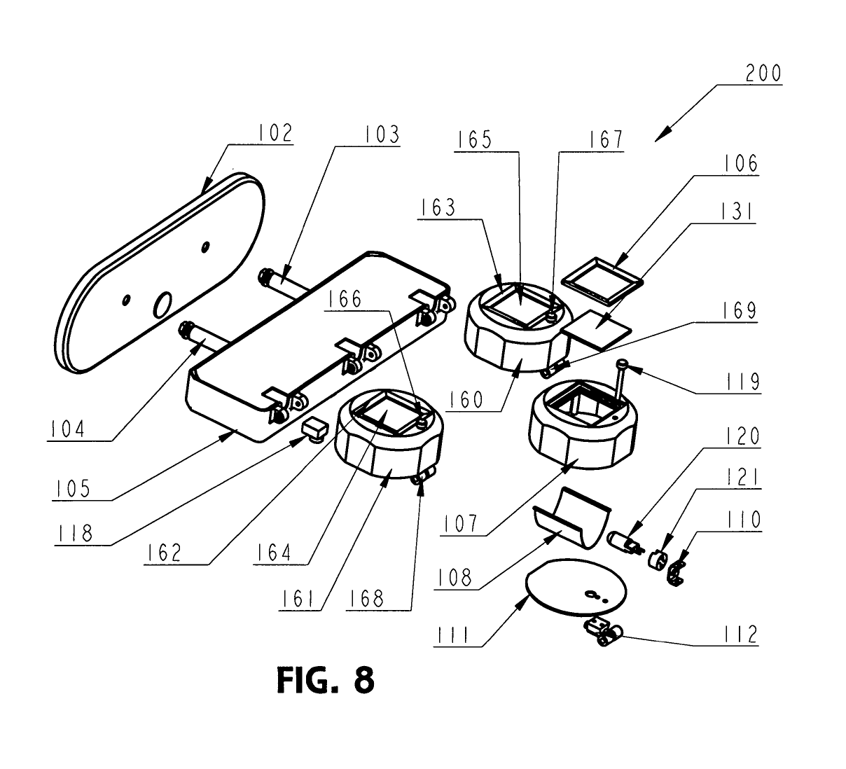

Referring now to FIG. 8, which is an explosive view of the second preferred embodiment 200 of current invention with a first light bulb housing 160, a second light bulb housing 107, a third light bulb housing 161, one retractable arm box 105, and one mounting base 102. Said lighting fixture 200 comprises first light bulb housing 160, a second light bulb housing 107, a third light bulb housing 161, a pivot connector 112, a retractable arm box 105, and a mounting base 102. Said first light bulb housing 160, said second light bulb housing 107, and said third light bulb housing 161 can be different or identical based on various needs and conditions. Said second light bulb housing 107 further comprises a second back light bulb housing cover 111, a second glass front light bulb housing cover 131, a second socket 121, said second socket 121 connected to said second light bulb housing 107 through a socket bracket 110 and adjust screw 119, a second light bulb 120, said second light bulb 120 connected to said second socket 121 and positioned between said second back light bulb housing cover 111 and said second glass front light bulb housing cover 131, a second reflector 108, said second reflector 108 connected to said second light bulb housing 107 and positioned between said second back light bulb housing cover 111 and said second light bulb 120. Said second pivot connector 112 connects said second light bulb housing 107 to said retractable arm box 105. Said retractable arm box 105 has a first retractable arm 103 and a second retractable arm 104. Both said first retractable arm 103 and said second retractable arm 104 are disposed within said retractable arm box 105, and capable of extending out through the wall of said retractable arm box 105. One end of both said first retractable arm 103 and said second retractable arm 104 are mounted onto said mounting base 102. The other end of both said first retractable arm 103 and said second retractable arm 104 are connected to said retractable arm box 105. The second light bulb 120 is connected to an electric power source through an electrical line and a switch. The second light bulb 120 can also be connected to said electric power source through a transformer.

Said second glass front light bulb housing cover 131 of said second lighting fixture 200 can be at an open position or a closed position. Said second socket 121 of said lighting fixture 200 can be a plurality of sockets, each of which has a second light bulb 120. The position of said second light bulb 120 can be adjusted through a second adjust screw 119 in order to change light beam angle to meet the intended ambient surrounding room light and direct illumination for specific surface area light. The position of said second reflector 108 relative to said second light bulb 120 can also be adjusted in order to change light beam angle to meet the intended ambient surrounding room light and direct illumination for specific surface area light. Said lighting fixture 200 has a second switch 118, which is capable of controlling volume of electricity flowing through said second light bulb 120 in order to control the output of luminance to meet intended requirement of ambient surrounding room light and direct illumination for specific surface area.

Said first light bulb housing 160 and said third light bulb housing 161 have the identical structure as that of said second light bulb housing 107. Of course, according to the different needs, said first light bulb housing 160, said second light bulb housing 107 and said third light bulb housing 161 could be different in sense of the power of the light bulbs, the length of the retractable arms, etc.

On top of the light bulb housing 107, there is a bulb adjust screw 119, which is capable of adjusting the position of the light bulb 120 and light bulb socket 121. There is a switch 118 on said retractable arm box 105. Said retractable arm box 105 is mounted onto said mounting base 102 through said first retractable arm 103 and said second retractable arm 104.

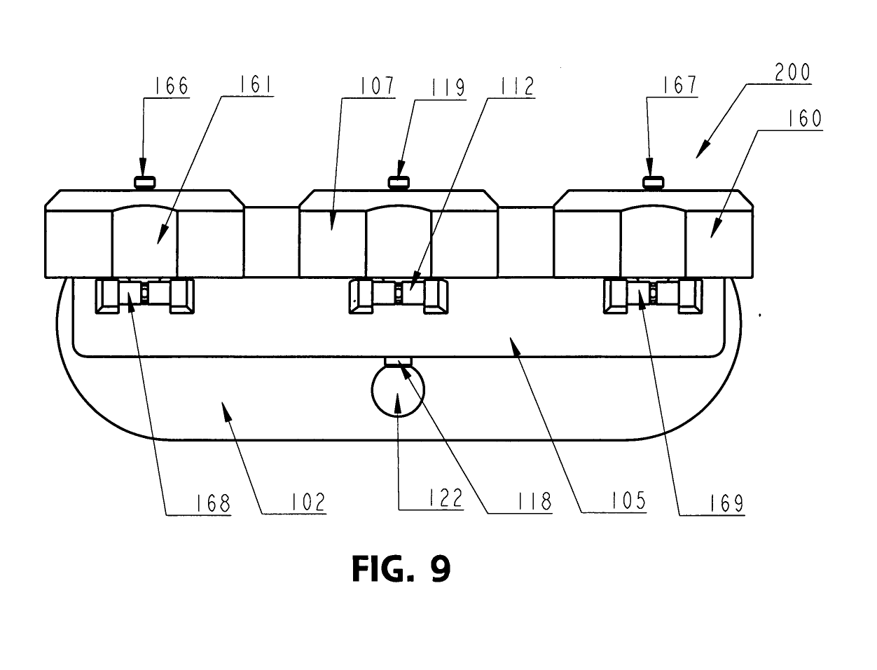

Referring now to FIG. 9, which is a front view of the second preferred embodiment 200 of current invention with a first light bulb housing 160, a second light bulb housing 107, a third light bulb housing 161, one retractable arm box 105, and one mounting base 102. All first light bulb housing 160, second light bulb housing 107, and third light bulb housing 161 are mounted on said retractable arm box 105 through pivot connectors 169, 112 and 168, respectively. There is also a clock 122 mounted on said mounting base 102. Said clock can be an alarm clock. When the alarm is in active, it can switch on said second preferred embodiment 200 to adjust the volume of electricity flowing through said light bulb 120 from zero to the full extent. On top of said second light bulb housing 107, there is a second bulb adjust screw 119, which can adjust the light beam angle to meet the intended purpose. Said light bulb housing 107 is connected to said retractable arm box 105 through said pivot connector 112, and capable of turning around the pivot connector 112 either flipping up and down, or turning left and right. Similarly, on top of the light bulb housing 160, there is a bulb adjust screw 167. Said light bulb housing 160 is connected to said retractable arm box 105 through said pivot connector 169, and capable of turning around the pivot connector 169 either flipping up and down, or turning left and right. Similarly, on top of the light bulb housing 161, there is a bulb adjust screw 166. Said light bulb housing 161 is connected to said retractable arm box 105 through said pivot connector 168, and capable of turning around the pivot connector 168 either flipping up and down, or tuning left and right.

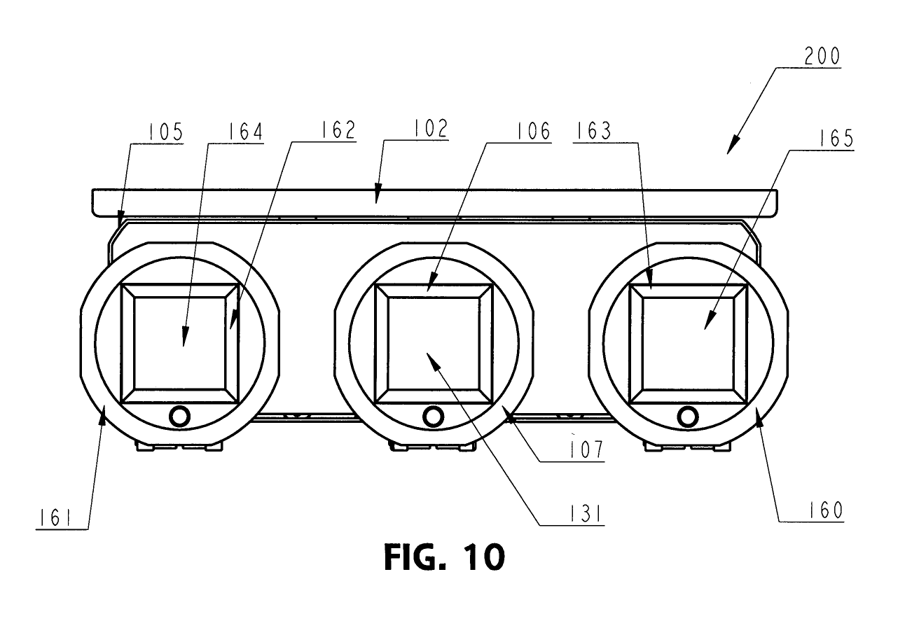

Referring now to FIG. 10, which is a top view of the second preferred embodiment 200 of the current invention with a first light bulb housing 160, a second light bulb housing 107, a third light bulb housing 161, one retractable arm box 105, and one mounting base 102. Said first light bulb housing 160 has a first glass front lighting housing cover 165 mounted onto said light bulb housing 160 through a first glass mounting frame 163. Said second light bulb housing 107 has a second glass front lighting housing cover 131 mounted onto said light bulb housing 107 through a second glass mounting frame 106. Said third light bulb housing 161 has a third glass front lighting housing cover 164 mounted onto said light bulb housing 161 through a third glass mounting frame 162.

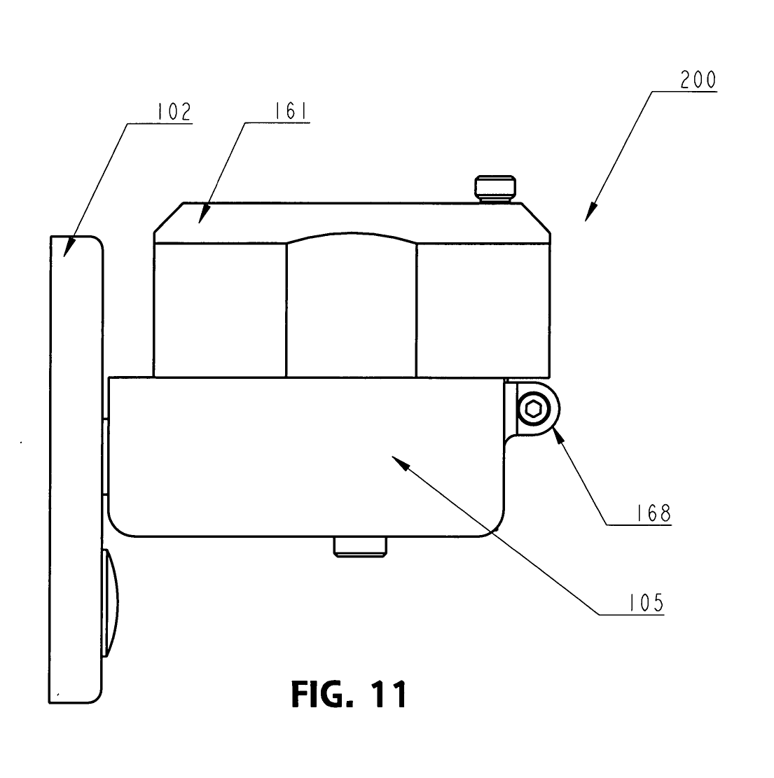

Referring now to FIG. 11, which is a side view of the second preferred embodiment 200 of the current invention with a first light bulb housing 160, a second light bulb housing 107, a third light bulb housing 161, one retractable arm box 105, and one mounting base 102. Said third light bulb housing 161 is capable of turning around said retractable arm box 105 through said third pivot connector 168. Said third light bulb housing 161 is positioned on top of said retractable arm box 105 and connected to said retractable arm box 105. Said retractable arm box 105 is mounted onto said mounting base 102.

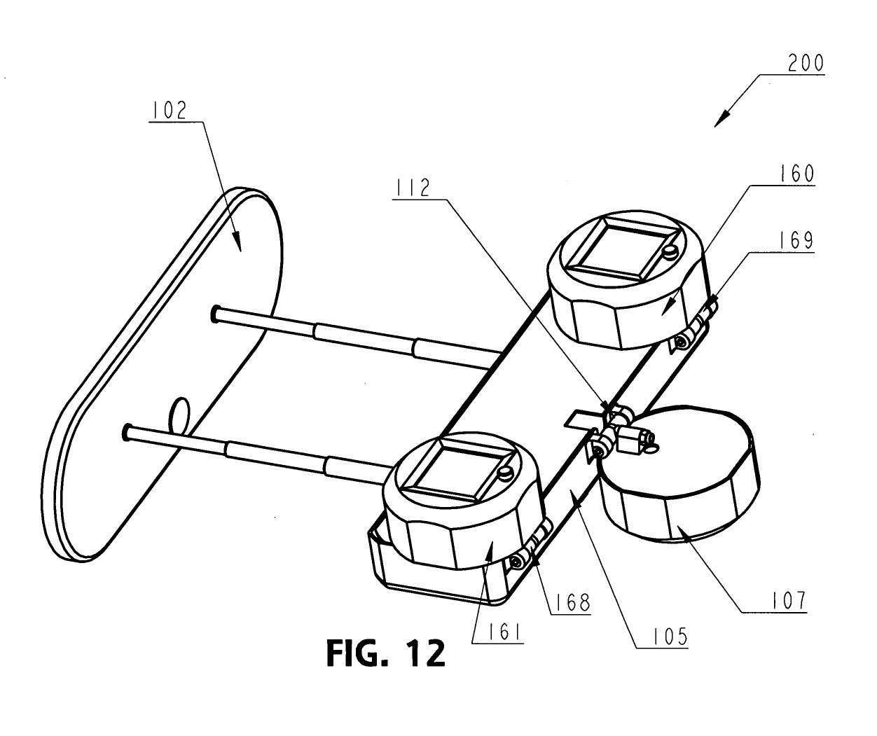

Referring now to FIG. 12, which is a three dimensional view of the second preferred embodiment 200 of the current invention with a first light bulb housing 160, a second light bulb housing 107, a third light bulb housing 161, one retractable arm box 105, and one mounting base 102. Said retractable arm box 105 is capable of extending away from said mounting base 102, when both said first retractable arm 103 and said second retractable arm 104 are extended out. Said first light bulb housing 160 is capable of flip down from its original up position showing in FIGS. 7, 9, 10 and 11 around said first pivot connector 169 to any preferred position, either flipping up and down or turning left and right. Said second light bulb housing 107 is capable of flip down from its original up position showing in FIGS. 7, 9, 10 and 11 around said second pivot connector 112 to any preferred position, either flipping up and down or turning left and right. Said third light bulb housing 161 is capable of flip down from its original up position showing in FIGS. 7, 9, 10 and 11 around said third pivot connector 168 to any preferred position, either flipping up and down or turning left and right. While the second preferred embodiment 200 of the current invention was positioned as shown in FIGS. 7, 9, 10 and 11, it is intended to provide ambient surrounding room light as either a wall sconce/wall wash light or a ceiling light. While the second preferred embodiment 200 of the current invention was positioned as shown in FIG. 12, it is intended to provide both ambient surrounding room light as either a wall sconce/wall wash light or a ceiling light and a direct illumination for a specific surface area as either a reading light, or working light, or picture light or display light.

More features could be added to said second preferred embodiment 200 of the current invention as said first preferred embodiment 100, such as the remote control feature. The second preferred embodiment 200 has significant advantage over said first preferred embodiment 100. The combination of these three light bulb housing 160, 107 and 161 at various positions relative to said mounting base 102, as well as to said retractable arm box 105, enables said second preferred embodiment 200 to provide both ambient surrounding room light and a direct illumination for a specific surface area.

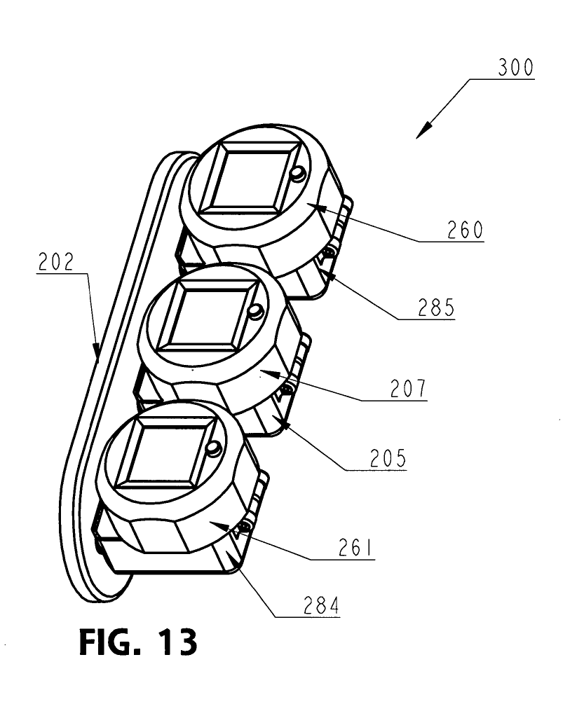

Referring now to FIG. 13, which is a three dimensional view of the third preferred embodiment 300 of current invention with a first light bulb housing 260, a second light bulb housing 207, a third light bulb housing 261, a first retractable arm box 285, a second retractable arm box 205, a third retractable arm box 284, and one mounting base 202.

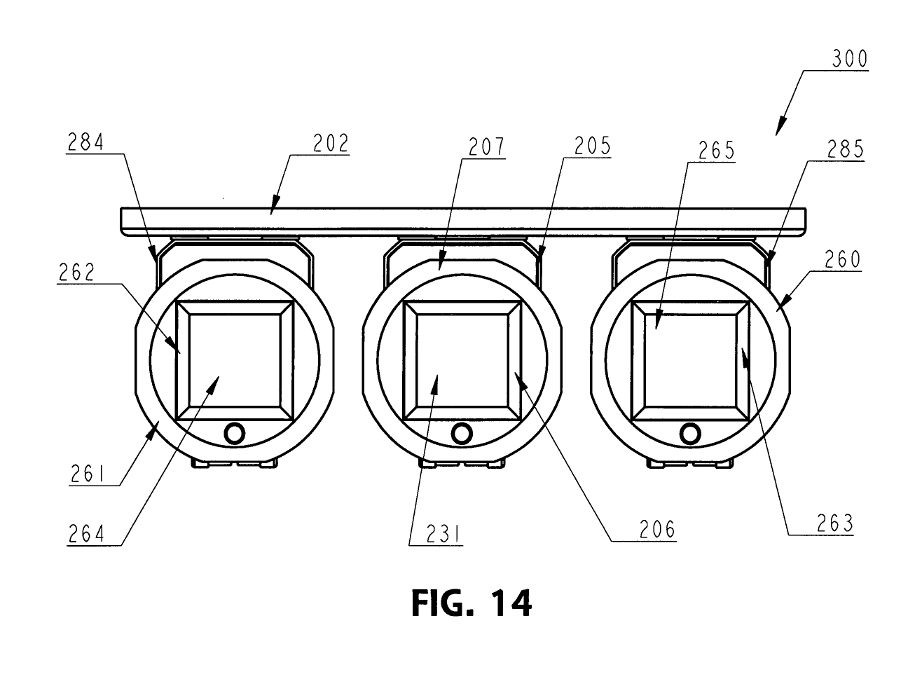

Referring now to FIG. 14, which is a top view of the third preferred embodiment 300 of the current invention with a first light bulb housing 260, a second light bulb housing 207, a third light bulb housing 261, a first retractable arm box 285, a second retractable arm box 205, a third retractable arm box 284, and one mounting base 202. Said first light bulb housing 260 has a first glass front light housing cover 265 mounted onto said first light bulb housing 260 through a first glass mounting frame 263. Said second light bulb housing 207 has a second glass front lighting housing cover 231 mounted onto said light bulb housing 207 through a second glass mounting frame 206. Said third light bulb housing 261 has a third glass front lighting housing cover 264 mounted onto said light bulb housing 261 through a third glass mounting frame 262.

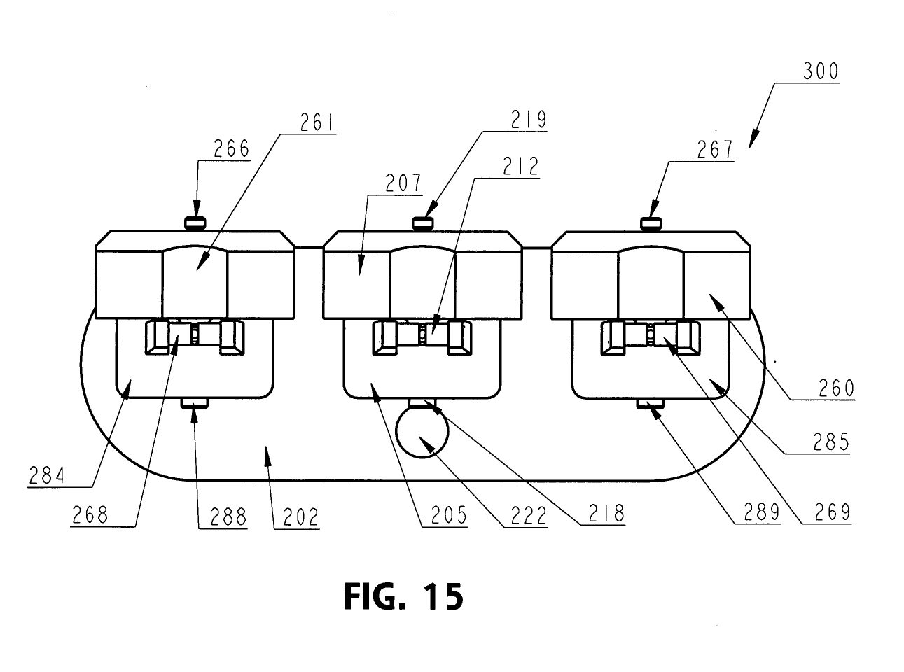

Referring now to FIG. 15, which is a front view of the third preferred embodiment 300 of current invention with a first light bulb housing 260, a second light bulb housing 207, a third light bulb housing 261, a first retractable arm box 285, a second retractable arm box 205, a third retractable arm box 284, and one mounting base 202. Said first light bulb housing 260 is mounted on said first retractable arm box 285. Said second light bulb housing 207 is mounted on said second retractable arm box 205. Said third light bulb housing 261 is mounted on said third retractable arm box 284. There is also a clock 222 mounted on said mounting base 202. On top of the light bulb housing 207, there is a bulb adjust screw 219, which can adjust the light beam angle to meet the requirement of intended ambient surrounding room light and direct illumination for specific surface area. Said light bulb housing 207 is connected to said retractable arm box 205 through said pivot connector 212, and capable of turning around the pivot connector 212, either flipping up and down or turning left and right. There is a switch 218 on said retractable arm box 205. Said retractable arm box 205 is mounted onto said mounting base 202. Similarly, on top of the light bulb housing 260, there is a bulb adjust screw 267, which can adjust the light beam angle to meet the requirement of intended ambient surrounding room light and direct illumination for specific surface area. Said light bulb housing 260 is connected to said retractable arm box 284 through said pivot connector 269, and capable of turning around the pivot connector 269, either flipping up and down or turning left and right. There is a switch 289 on said retractable arm box 285. Similarly, on top of the light bulb housing 261, there is a bulb adjust screw 266, which can adjust the light beam angle to meet the requirement of intended ambient surrounding room light and direct illumination for specific surface area. Said light bulb housing 261 is connected to said retractable arm box 285 through said pivot connector 268, and capable of turning around the pivot connector 268, either flipping up and down or turning left and right. There is a switch 288 on said retractable arm box 284.

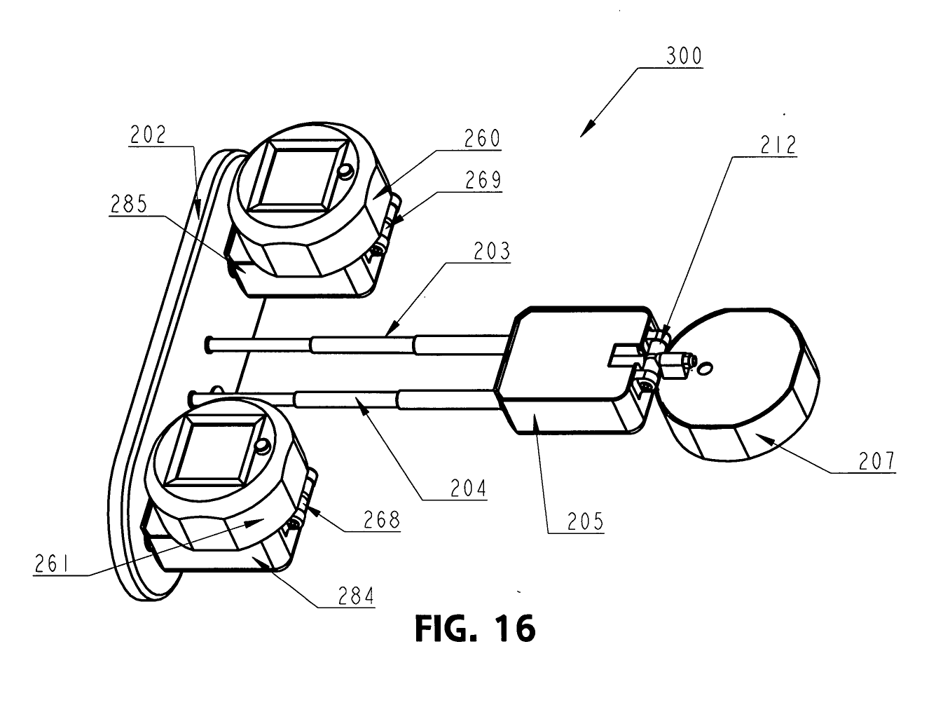

Referring now to FIG. 16, which is a three dimensional view of the third preferred embodiment 300 of the current invention with a first light bulb housing 260, a second light bulb housing 207, a third light bulb housing 261, a first retractable arm box 285, a second retractable arm box 205, a third retractable arm box 284, and one mounting base 202. Said second retractable arm box 205 is capable of extending away from said mounting base 202, when both said first retractable arm 203 and said second retractable arm 204 are extended out. Similar as second retractable arm box 205, the first and third retractable arm box 285, 284 are capable of extending away from said mounting base 202. Said first light bulb housing 260 is capable of flip down from its original up position showing in FIGS. 13, 14 and 15 around said first pivot connector 269 to any preferred position, either flipping up and down or turning left and right. Said second light bulb housing 207 is capable of flip down from its original up position showing in FIGS. 13, 14 and 15 around said second pivot connector 212 to any preferred position, either flipping up and down or turning left and right. Said third light bulb housing 261 is capable of flip down from its original up position showing in FIGS. 13, 14, and 15 around said third pivot connector 268 to any preferred position, either flipping up and down or turning left and right. While the third preferred embodiment 300 of the current invention was positioned as shown in FIGS. 13, 14 and 15, it is intended to provide ambient surrounding room light as either a wall sconce/wall wash light or a ceiling light. While the third preferred embodiment 300 of the current invention was positioned as shown in FIG. 16, it is intended to provide both ambient surrounding room light as either a wall sconce/wall wash light or a ceiling light and a direct illumination for a specific surface area as either a reading light, or working light, or picture light, or display light.

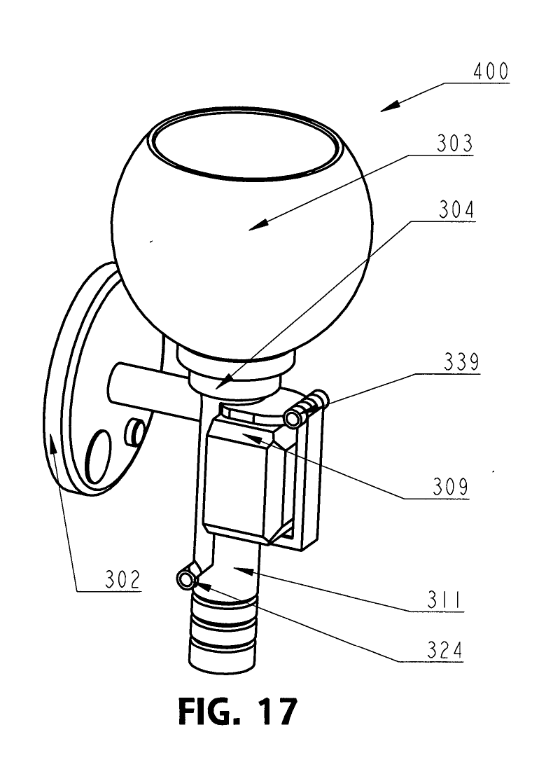

Referring now to FIG. 17, which is a three dimensional view of the fourth preferred embodiment 400 of the current invention with two light bulb housings 303 and 309, one folded arm 311 and one mounting base 302. Said first light bulb housing 303 is mounted onto said mounting base 302 through a first light bulb housing arm 304. Said second light bulb housing 309 is connected to said first light bulb housing arm 304 through a folded arm 311. Said folded arm 311 is connected to said first light bulb housing arm 304 through a first pivot connector 324. Said second light bulb housing 309 is connected to said folded arm 311 through said second pivot connector 339.

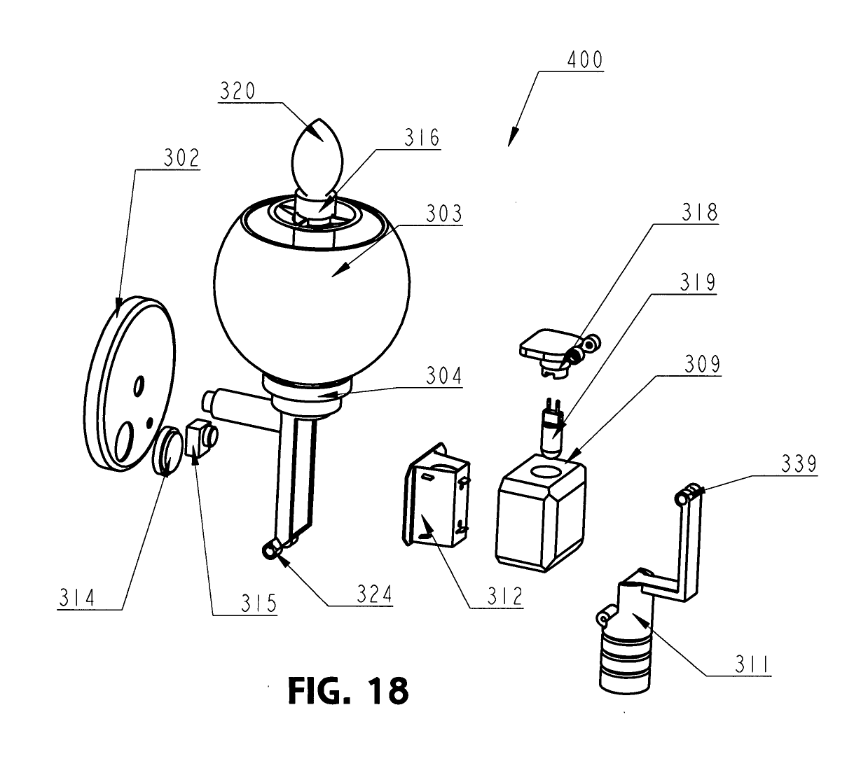

Referring now to FIG. 18, which is an explosive view of the fourth preferred embodiment 400 of the current invention with two light bulb housings 303 and 309, one folded arm 311 and one mounting base 302. Said fourth preferred embodiment 400 comprises a first light bulb housing 303, said first light bulb housing containing a first socket 316, a first light bulb 320, said first light bulb 320 connected to said first socket 316; a first light bulb housing arm 304, said first light bulb housing arm 304 connected to said first light bulb housing 303; a second light bulb housing 309, said second light bulb housing 309 containing a reflector 312, a second socket 318, a second light bulb 319, said second light bulb 319 connected to said second socket 318, said reflector 312 positioned between said second light bulb 319 and said second light bulb housing 309; a folded arm 311, said folded arm 311 connected to said second light bulb housing 309. Both said first light bulb 320 and said second light bulb 319 are connected to an electricity source through electrical lines. Both said first light bulb 320 and said second light bulb 319 are controlled by a switch 315 mounted on said mounting base 302. There is also a clock 314 mounted on said mounting base 302. Said clock can be an alarm clock. When the alarm is in active, it can adjust the flow of electricity through both said first light bulb 320 and said second light bulb 319 according to a pre-programmed pattern.

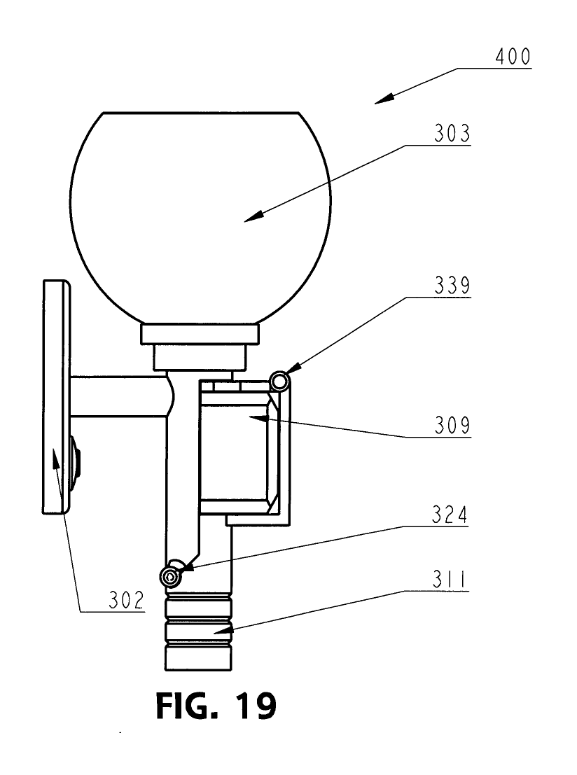

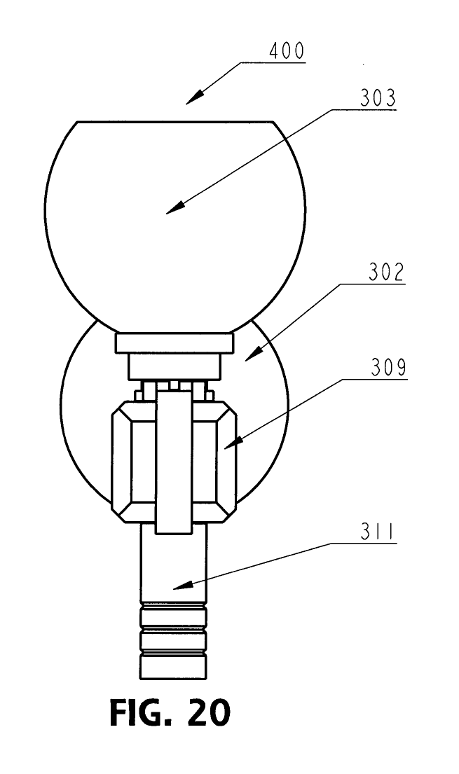

Referring now to FIG. 19, which is a side view, and FIG. 20, which is a front view, of the fourth preferred embodiment 400 of the current invention with two light bulb housings 303 and 309, one folded arm 311 and one mounting base 302. Said unfolded arm 311 is capable of turning around said first pivot connector 324, and extending said second light bulb housing 309 away from said first light bulb housing 303. Said second light bulb housing 309 is capable of turning around said second pivot connector 339, either flipping up and down or turning left and right.

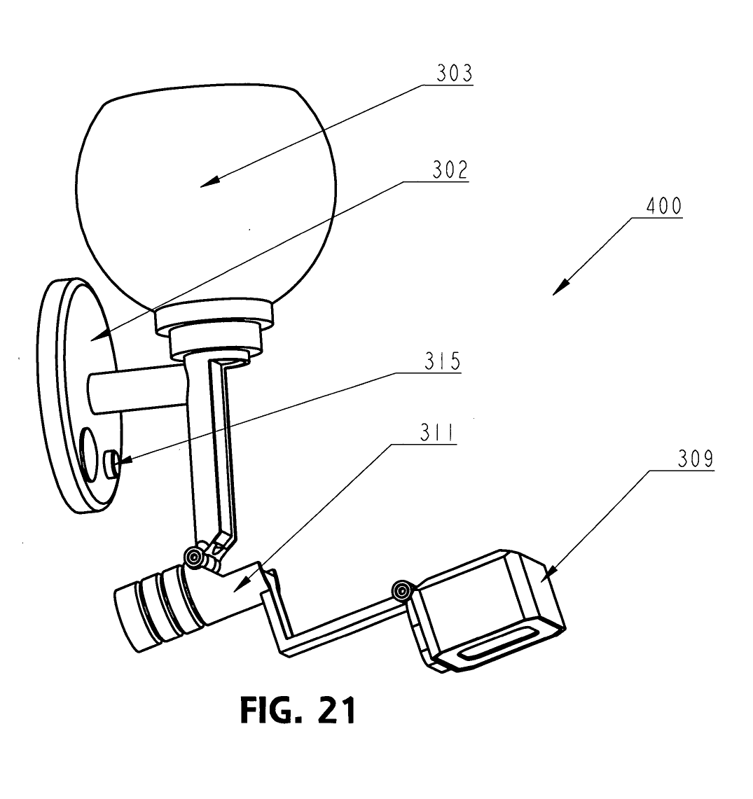

Referring now to FIGS. 18 and 21. FIG. 21 is a three dimensional view of the fourth preferred embodiment 400 of the current invention with two light bulb housings 303 and 309, one folded arm 311 and one mounting base 302, with folded arm 311 unfolded. The switch 315 mounted on said mounting base 302 is capable of controlling the electricity volume flow through both the first light bulb 320 and the second light bulb 319, in order to control the output of luminance to meet the requirement of the intended purpose. While the fourth preferred embodiment 400 of the current invention was positioned as shown in FIGS. 17 through 20, it is intended to provide ambient surrounding room light as a wall sconce light. While the fourth preferred embodiment 400 of the current invention was positioned as shown in FIG. 21, it is intended to provide both ambient surrounding room light as a wall sconce light and a direct illumination for a specific surface area as either a reading light or working light, if both the first light bulb 320 and the second light bulb 319 are on. If only the second light bulb is on, the fourth preferred embodiment 400 of the current invention as shown in FIG. 21 was intended to function as only a reading, or working light, or picture light, or display light.

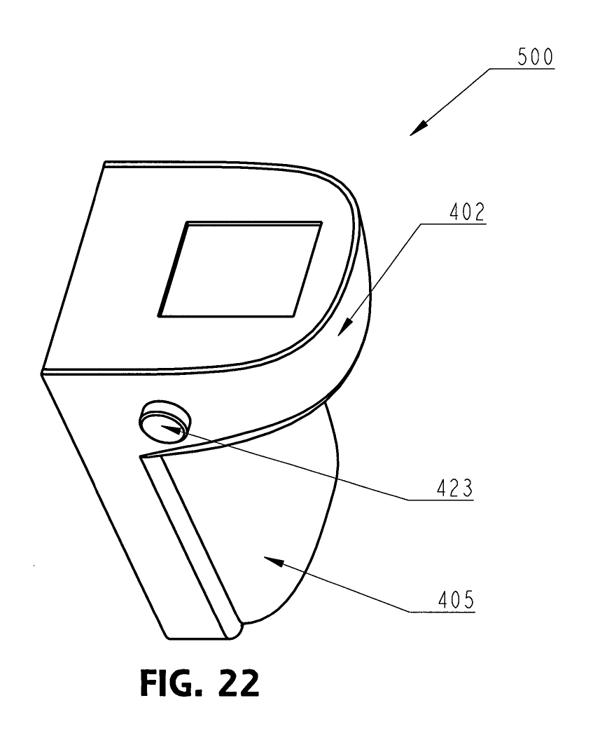

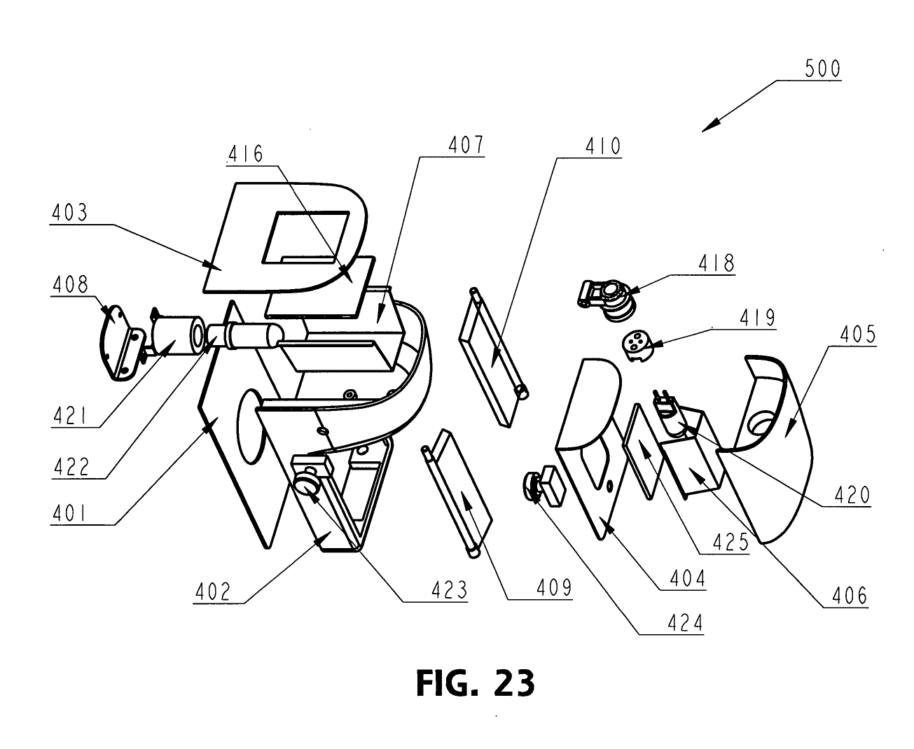

Referring now to FIGS. 22 and 23. FIG. 22 is a three dimensional view of the fifth preferred embodiment 500 of the current invention with two light bulb housings 402 and 405, one set of retractable arms 409 and 410, and one mounting base 401. The fifth preferred embodiment 500 of the current invention comprises a first light bulb housing 402, a second light bulb housing 405, said second light bulb housing 405 connecting to said first light bulb housing 402 through a set of retractable arms 409 and 410. There is a first switch 423 mounted on said first light bulb housing 402.

Referring now to FIG. 23, which is an explosive view of the fifth preferred embodiment 500 of the current invention with two light bulb housings 402 and 405, one set of retractable arms 409 and 410, and one mounting base 401. Said first light bulb housing 402 comprises a first reflector 407, a first socket 421, a first light bulb 422, a first light bulb housing glass cover 416, a first socket mounting bracket 408, and a first light bulb housing cover 403. Said second light bulb housing 405 comprises a second reflector 406, a second socket 419, a second light bulb 420, a second light bulb housing cover 404, and a second light bulb housing glass cover 425. Said second light bulb housing 405 is connected to said one set of retractable arm 409 and 410 through a pivot connector 418. Said pivot connect 418 enables said second light bulb housing 405 to position around said pivot connect 418 to any preferred position, either flipping up and down or turning left and right.

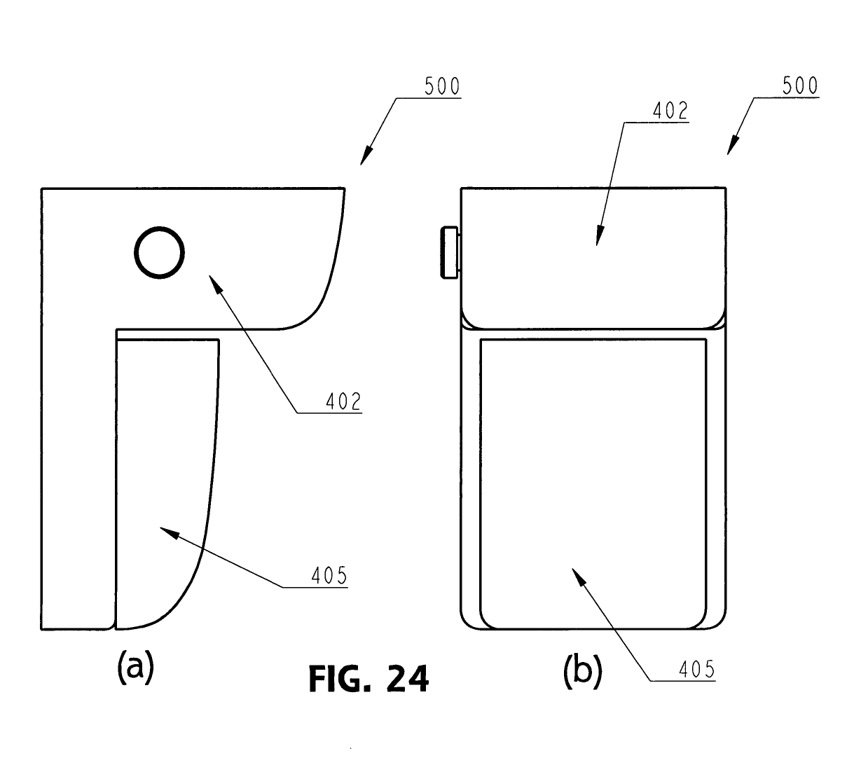

Referring now to FIG. 24(a), which is a side view of the fifth preferred embodiment 500 of the current invention, and FIG. 24(b), which is a front view of the fifth preferred embodiment 500 of the current invention. Both FIGS. 24(a) and (b) show the close position of the current invention as a wall sconce/wall wash light.

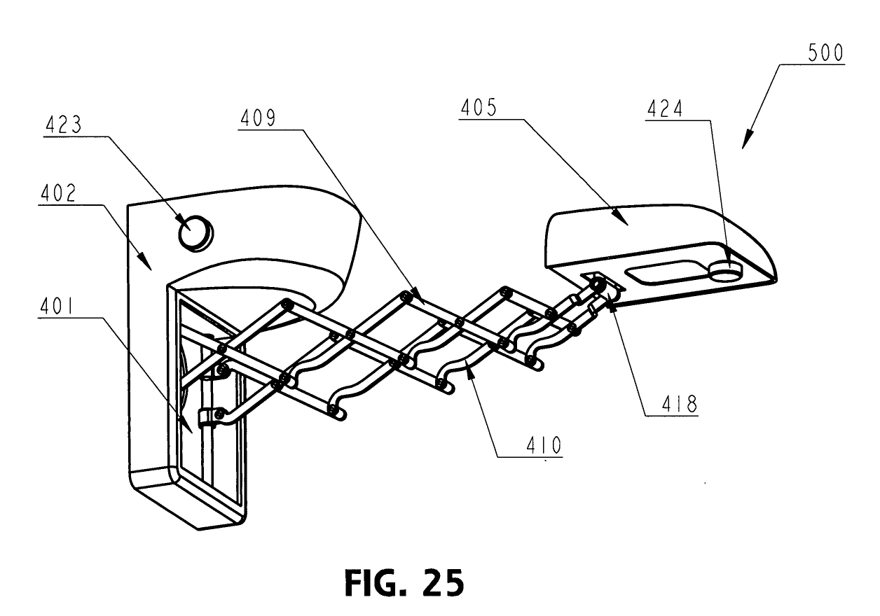

Referring now to FIGS. 23 and 25. FIG. 25 is a three dimensional view of the fifth preferred embodiment 500 of the current invention with two light bulb housings 402 and 405, one set of retractable arms 409 and 410, and one mounting base 401, with said set of retractable arms 409 and 410 extending out. There is a first switch 423 mounted on said first light bulb housing 402, which is capable of controlling the electricity flowing through said first light bulb 422. There is a second switch 424 mounted on said second light bulb housing 405, which is capable of controlling the electricity flowing through said second light bulb 420. Said second light bulb housing 405 is capable of extending away from said first light bulb housing 402, when said set of retractable arms 409 and 410 extends out. Said second light bulb housing 405 is connecting to said set of retractable arms 409 and 410 through a pivot connector 418, and capable of turning around said pivot connector 418, either flipping up and down or tuning left and right. While the fifth preferred embodiment 500 of the current invention was positioned as shown in FIGS. 22 through 24, it is intended to provide ambient surrounding room light as either a wall sconce/wall wash light or a ceiling light. While the fifth preferred embodiment 500 of the current invention was positioned as shown in FIG. 25, it is intended to provide both ambient surrounding room light as a wall sconce/wall wash light and a direct illumination for a specific surface area as either a reading light or working light or picture light or display light, if both the first light bulb 422 and the second light bulb 420 are on. If only the second light bulb 420 is on, the fifth preferred embodiment 500 of the current invention as shown in FIG. 25 was intended to function as only a reading, or working light, or picture light, or display light.

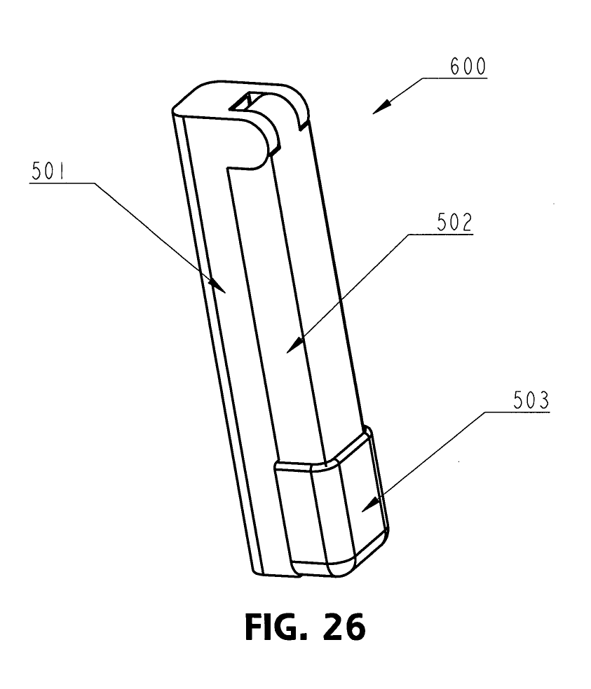

Referring now to FIG. 26, which is a three dimensional view of the sixth preferred embodiment 600 of the current invention with one light bulb housing 503, one retractable arm box 502 and one mounting base 501. FIG. 26 shows the sixth preferred embodiment 600 of the current invention in a closed up position.

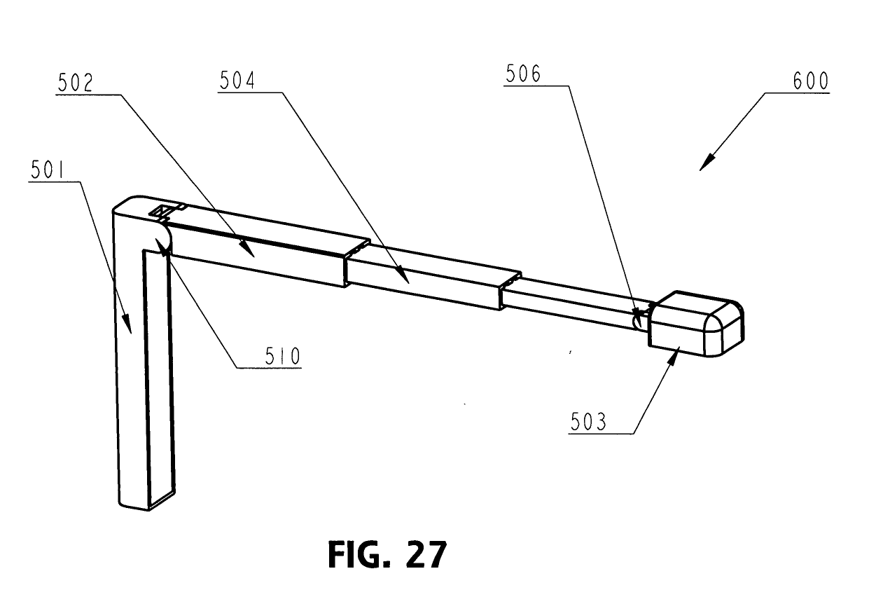

Referring now to FIG. 27, which is a three dimensional view of the sixth preferred embodiment 600 of the current invention with one light bulb housing 503, one retractable arm box 502 and one mounting base 501, with retractable arm 504 extending out from the retractable arm box 502. Said light bulb housing 503 is connected to said retractable arm 504 through a first pivot connector 506. Said first pivot connector 506 enables said light bulb housing 503 to any preferred position, either flipping up and down or turning left and right. Said retractable arm box 502 is connected to said mounting base 501 through a second pivot connector 510. While the sixth preferred embodiment 600 of the current invention was positioned as shown in FIG. 27, it is intended to provide a direct illumination for a specific surface area as either a reading light, or working light, or picture light, or display light. Both the first pivot connector 506 and said second pivot connector 510 enables the sixth preferred embodiment to be either a wall sconce/wall wash light, or reading light, or working light, or picture light, or display light.

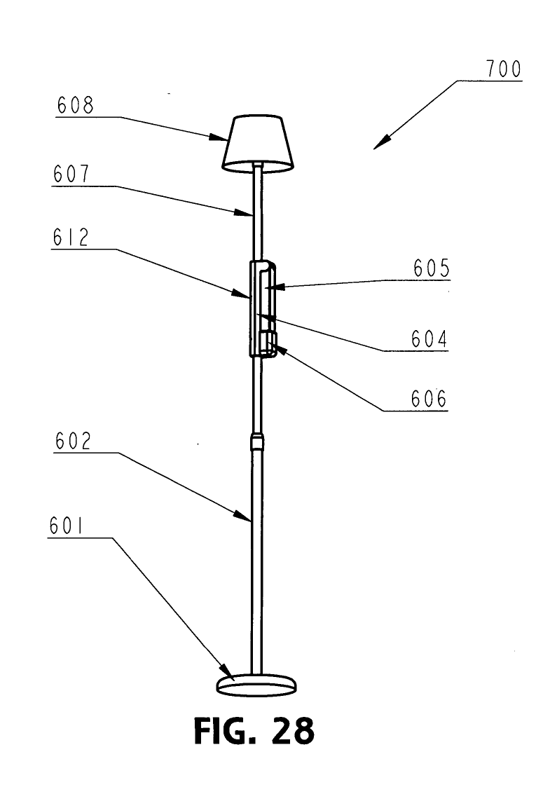

Referring now to FIG. 28, which is a three dimensional view of the seventh preferred embodiment 700 of the current invention with one light bulb housing 606, one retractable arm box 605, one mounting base 604, and one mounting member 612, attached to a stand along lighting fixture 602. Said stand along lighting fixture 602 comprises a lighting fixture base 601, a light fixture stem 607, and a light fixture bulb housing 608. Said mounting base 604 and said mounting member 612 together are capable of mounting said sixth preferred embodiment 600 onto said light fixture stem 607.

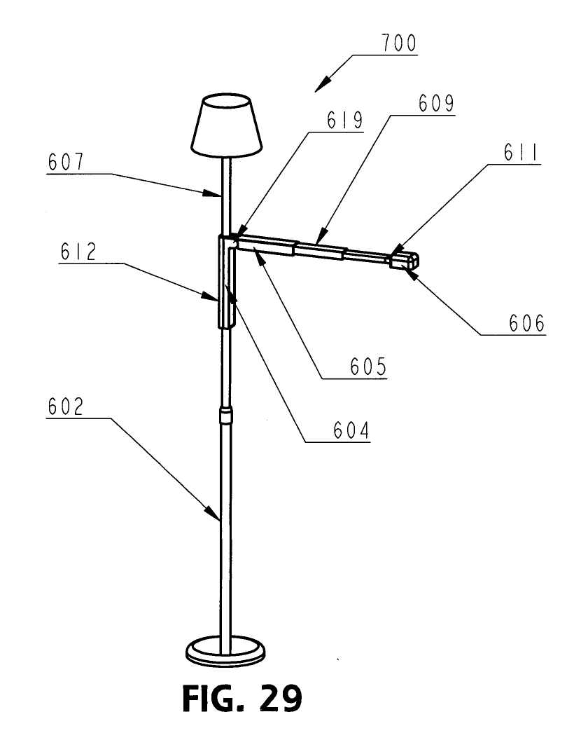

Referring now to FIG. 29, which is a three dimensional view of the seventh preferred embodiment 700 of the current invention with one light bulb housing 606, one retractable arm box 605, one mounting base 604, and one mounting member 612, with said retractable arm 609 unfolded and extended from a stand along lighting fixture 602. Said mounting base 604 and said mounting member 612 could attach said sixth preferred embodiment 600 of the current invention to any position on said light fixture stem 607. While the sixth preferred embodiment 600 of the current invention was positioned as shown in FIG. 29, it is intended to provide a direct illumination for a specific surface area as either a reading light or working light. The lighting bulb housing 606 is capable to flip up down and turn left or right around the first pivot connector 611. The retractable arm box 605 also is capable of flip up down around the second pivot connector 619.

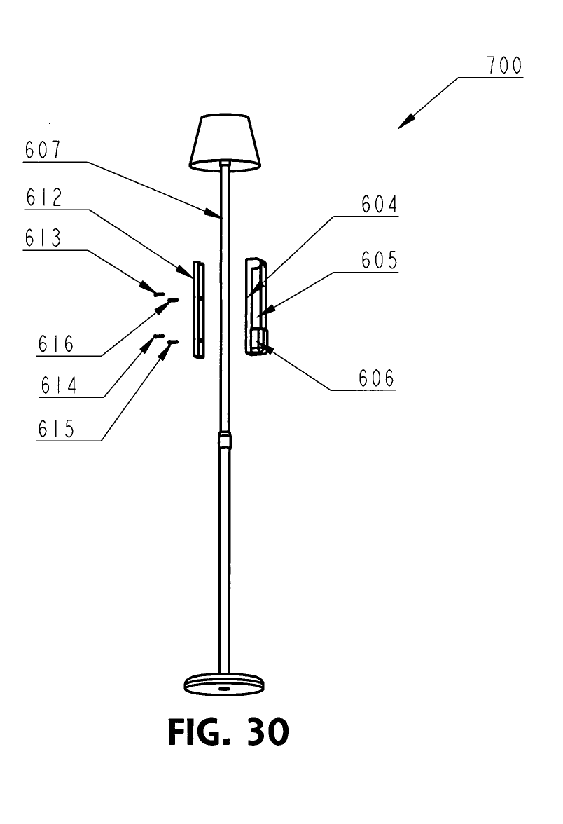

Referring now to FIG. 30, which is a partially explosive view of the seventh preferred embodiment 700 of the current invention with one light bulb housing 606, one retractable arm box 605, one mounting base 604, and one mounting member 612, attached to a stand along lighting fixture. Said mounting member 612 is attached to said mounting base 604 through 4 screws 613 through 616, with said light fixture stem 607 positioned between said mounting base 604 and said mounting member 612.

The seventh preferred embodiment 700 of the current invention provides an added on foldable reading or working light to an existing light standing on the ground.

As various possible embodiments may be made in the above invention for use for different purposes and as various changes might be made in the embodiments and methods above set forth, it is understood that all of the above matters here set forth or shown in the accompanying drawings are to be interpreted as illustrative and not in a limiting sense.

I claim:

1. A retractable and adjustable multi-purpose indoor lighting fixture capable of providing both ambient surrounding room light and direct illumination for a specific surface area, said lighting fixture comprising:
a light bulb housing, said light bulb housing further comprising a back light bulb housing cover, a light bulb housing wall, a glass front light bulb housing cover, a socket, said socket connected to said light bulb housing wall, a light bulb, said light bulb connected to said socket and positioned between said back light bulb housing cover and said glass front light bulb housing cover, a reflector, said reflector connected to said light bulb housing wall and positioned between said back light bulb housing cover and said light bulb;
a pivot connector, said pivot connector having a first pivot end and a second pivot end, said first pivot end connected to said light bulb housing;
a retractable arm box, said retractable arm box connected to said second pivot end;
a retractable arm set, said retractable arm set having a first retractable arm end and a second retractable arm end, said first retractable arm end connected to said retractable arm box;
a mounting base, said mounting base having a first mounting base end and a second mounting base end, said first mounting base end connected to said second retractable arm end, and said second mounting base end mounted onto a wall; and
an electrical line, said electrical line having a first electrical line end and a second electrical line end, said first electrical line end connected to said light bulb, said second electrical line end connected to an electric power source.

2. The lighting fixture of claim 1, wherein said glass front light bulb housing cover can be at an open position or a closed position.

3. The lighting fixture of claim 1, wherein said socket can be a plurality of sockets, each socket having a light bulb.

4. The lighting fixture of claim 1, wherein either said light bulb or said reflector is adjustable.

5. The lighting fixture of claim 1, wherein said light bulb is connected to a switch, said switch capable of controlling volume of electricity flowing through said light bulb.

6. The lighting fixture of claim 1, wherein said retractable arm set has a plurality of retractable arms, all of which can be retracted and deposited into said retractable arm box.

7. The lighting fixture of claim 1, wherein said light bulb housing can be a plurality of light bulb housings.

8. The lighting fixture of claim 1, wherein said pivot connector can be a plurality of pivot connectors.

9. The lighting fixture of claim 1, wherein said retractable arm set can be a plurality of retractable arm sets.

10. The lighting fixture of claim 1, wherein said mounting base can be a plurality of mounting bases.

11. The lighting fixture of claim 1, wherein said electrical line can be a plurality of electrical lines.

12. The lighting fixture of claim 1 further comprises a transformer, said transformer connecting said light bulb to said electric power source.

13. A retractable and adjustable multi-purpose indoor lighting fixture capable of providing both ambient surrounding room light and direct illumination for a specific surface area, said lighting fixture comprising:
a light bulb housing, said light bulb housing containing a reflector, a socket, a light bulb, said light bulb connected to said socket, said reflector positioned between said light bulb and said light bulb housing;
a retractable arm box, said retractable arm box having a retractable arm set;
a pivot connector, said pivot connector connecting said light bulb housing to said retractable arm box;
a mounting base, said mounting base connecting said retractable arm box to a wall or alike; and
an electrical line, said electrical line connecting said light bulb to an electric power source.

14. The lighting fixture of claim 13, wherein said light bulb housing further comprises a light bulb housing wall and an adjustable light bulb housing cover, said adjustable light bulb housing cover being transparent.

15. The lighting fixture of claim 13, wherein said socket can be a plurality of sockets.

16. The lighting fixture of claim 13, wherein either said light bulb or said reflector is adjustable.

17. The lighting fixture of claim 13, wherein said light bulb is connected to a switch, said switch capable of controlling volume of electricity flowing through said light bulb.

18. The lighting fixture of claim 13, wherein said light bulb can be a plurality of light bulbs.

19. The lighting fixture of claim 13, wherein said retractable arm set has a plurality of retractable arms, all of which can be retracted and deposited into said retractable arm box.

20. The lighting fixture of claim 13, wherein said light bulb housing can be a plurality of light bulb housings.

21. The lighting fixture of claim 13, wherein said pivot connector can be a plurality of pivot connectors.

22. The lighting fixture of claim 13, wherein said retractable arm set can be a plurality of retractable arm sets.

23. The lighting fixture of claim 13, wherein said mounting base can be a plurality of mounting bases.

24. The lighting fixture of claim 13, wherein said electrical line can be a plurality of electrical lines.

25. The lighting fixture of claim 13 further comprises a transformer, said transformer connecting said lighting fixture to said electric power source.

26. A retractable and adjustable multi-purpose indoor lighting fixture capable of providing both ambient surrounding room light and direct illumination for a specific surface area, said lighting fixture comprising:
a light bulb housing, said light bulb housing containing a lighting source;
an arm box, said arm box having an arm set, said arm set having a first arm set end and a second arm set end, said first arm set end connected to said arm box;
a pivot connector, said pivot connector connecting said light bulb housing to said arm box;
a mounting base, said mounting base connecting said second arm set end to a wall or alike; and
an electrical line, said electrical line connecting said lighting source to an electric power source.

27. The lighting fixture of claim 26, wherein said light bulb housing further comprises a light bulb housing wall and a light bulb housing cover, said light bulb housing cover being transparent.

28. The lighting fixture of claim 26, wherein said lighting source further comprises a plurality of lighting sources.

29. The lighting fixture of claim 26, wherein said arm set is adjustable or extendable.

30. The lighting fixture of claim 26, wherein said lighting source is connected to a switch, said switch capable of controlling volume of electricity flowing through said lighting source.

31. The lighting fixture of claim 26, wherein said light bulb housing can be a plurality of light bulb housings.

32. The lighting fixture of claim 26, wherein said pivot connector can be a plurality of pivot connectors.

33. The lighting fixture of claim 26, wherein said arm set can be a plurality of arm sets.

34. The lighting fixture of claim 26, wherein said mounting base can be a plurality of mounting bases.

35. The lighting fixture of claim 26, wherein said electrical line can be a plurality of electrical lines.

36. The lighting fixture of claim 26 further comprises a transformer, said transformer connecting said lighting source to said electric power source.

37. A retractable and adjustable multi-purpose indoor lighting fixture capable of providing both ambient surrounding room light and direct illumination for a specific surface area, said lighting fixture comprising:
a lighting source;
an arm set, said arm set having a first arm set end and a second arm set end, said first arm set end connected to said lighting source, said second arm set end connected to a mounting base; and
an electrical line, said electrical line connecting said lighting source to an electric power source.

38. The lighting fixture of claim 37, wherein said lighting source further comprises a lighting source housing.

39. The lighting fixture of claim 37, wherein said lighting source further comprises a transparent lighting source cover.

40. The lighting fixture of claim 37, wherein said lighting source further comprises a lighting source switch, said lighting source switch capable of adjusting volume of electricity flowing through said lighting source.

41. The lighting fixture of claim 37, wherein said lighting source further comprises a plurality of lighting sources.

42. The lighting fixture of claim 37, wherein said arm set is extendable.

43. The lighting fixture of claim 37, wherein said arm set can be a plurality of arm sets.

44. The lighting fixture of claim 37, wherein said mounting base can be a plurality of mounting bases.

45. The lighting fixture of claim 37, wherein said electrical line can be a plurality of electrical lines.

46. The lighting fixture of claim 37 further comprises a transformer, said transformer connecting said lighting source to said electric power source.

47. A retractable and adjustable multi-purpose indoor lighting fixture capable of providing both ambient surrounding room light and direct illumination for a specific surface area, said lighting fixture comprising:
a first light bulb housing, said first light bulb housing further comprising a first back light bulb housing cover, a first light bulb housing wall, a first glass front light bulb housing cover, a first socket, said first socket connected to said first light bulb housing wall, a first light bulb, said first light bulb connected to said first socket and positioned between said first back light bulb housing cover and said first glass front light bulb housing cover, a first reflector, said first reflector connected to said first light bulb housing wall and positioned between said first back light bulb housing cover and said first light bulb;
a first light bulb housing arm, said first light bulb housing arm connected to said first light bulb housing;
a mounting arm, said mounting arm having a first mounting arm end and a second mounting arm end, said first mounting arm end connected to said first light bulb housing arm;
a second light bulb housing, said second light bulb housing further comprising a second back light bulb housing cover, a second light bulb housing wall, a second glass front light bulb housing cover, a second socket, said second socket connected to said second light bulb housing wall, a second light bulb, said second light bulb connected to said second socket and positioned between said second back light bulb housing cover and said second glass front light bulb housing cover, a second reflector, said second reflector connected to said second light bulb housing wall and positioned between said second back light bulb housing cover and said second light bulb;
a second light bulb housing arm, said second light bulb housing arm connected to said second light bulb housing;
a pivot connector, said pivot connector having a first pivot end and a second pivot end, said first pivot end connected to said first light bulb housing arm, said second pivot end connected to said second light bulb housing arm;
a mounting base, said mounting base having a first mounting base end and a second mounting base end, said first mounting base end connected to said second mounting arm end, and said second mounting base end mounted onto a wall;
a first electrical line, said first electrical line having a first electrical line end and a second electrical line end, said first electrical line end connected to said first light bulb, said second electrical line end connected to an electric power source; and
a second electrical line, said second electrical line having a third electrical line end and a fourth electrical line end, said third electrical line end connected to said second light bulb, said fourth electrical line end connected to said electric power source.

48. The lighting fixture of claim 47, wherein said first socket can be a plurality of first sockets, each of which having a first light bulb.

49. The lighting fixture of claim 47, wherein said second socket can be a plurality of second sockets, each of which having a second light bulb.

50. The lighting fixture of claim 47, wherein either said first light bulb or said first reflector is adjustable.

51. The lighting fixture of claim 47, wherein either said second light bulb or said second reflector is adjustable.

52. The lighting fixture of claim 47, wherein said first light bulb is connected to a first switch, said first switch capable of controlling volume of electricity flowing through said first light bulb.

53. The lighting fixture of claim 47, wherein said second light bulb is connected to a second switch, said second switch capable of controlling volume of electricity flowing through said second light bulb.

54. The lighting fixture of claim 47, wherein both said first light bulb and said second light bulb are connected to a switch, said switch capable of controlling volume of electricity flowing through both said first light bulb and said second light bulb.

55. The lighting fixture of claim 47, wherein said first light bulb housing can be a plurality of first light bulb housings.

56. The lighting fixture of claim 47, wherein said second light bulb housing can be a plurality of second light bulb housings.

57. The lighting fixture of claim 47, wherein said pivot connector can be a plurality of pivot connectors.

58. The lighting fixture of claim 47, wherein said mounting base can be a plurality of mounting bases.

59. The lighting fixture of claim 47, wherein both said first electrical line and said second electrical line can be a plurality of electrical lines.

60. The lighting fixture of claim 47 further comprises a transformer, said transformer connecting both said first light bulb and said second light bulb to said electric power source.

61. A retractable and adjustable multi-purpose indoor lighting fixture capable of providing both ambient surrounding room light and direct illumination for a specific surface area, said lighting fixture comprising:
a first light bulb housing, said first light bulb housing containing a first reflector, a first socket, a first light bulb, said first light bulb connected to said first socket, said first reflector positioned between said first light bulb and said first light bulb housing;
a first light bulb housing arm, said first light bulb housing arm connected to said first light bulb housing;
a second light bulb housing, said second light bulb housing containing a second reflector, a second socket, a second light bulb, said second light bulb connected to said second socket, said second reflector positioned between said second light bulb and said second light bulb housing;
a second light bulb housing arm, said second light bulb housing arm connected to said second light bulb housing;
a pivot connector, said pivot connector connecting said first light bulb housing arm to said second light bulb housing arm;
a mounting base, said mounting base connecting said first light bulb housing arm to a wall or alike; and
an electrical line, said electrical line connecting both said first light bulb and said second light bulb to an electric power source.

62. The lighting fixture of claim 61, wherein said first light bulb housing further comprises a first light bulb housing wall and a first adjustable light bulb housing cover, said first adjustable light bulb housing cover being transparent.

63. The lighting fixture of claim 61, wherein said second light bulb housing further comprises a second light bulb housing wall and a second adjustable light bulb housing cover, said second adjustable light bulb housing cover being transparent.

64. The lighting fixture of claim 61, wherein both said first socket and said second socket can be a plurality of sockets.

65. The lighting fixture of claim 61, wherein the light beam angle of either said first light bulb or said second light bulb or both are adjustable.

66. The lighting fixture of claim 61, wherein said first light bulb is connected to a first switch, said first switch capable of controlling volume of electricity flowing through said first light bulb.

67. The lighting fixture of claim 61, wherein said second light bulb is connected to a second switch, said second switch capable of controlling volume of electricity flowing through said second light bulb.

68. The lighting fixture of claim 61, wherein both said first light bulb and said second light bulb are connected to a switch, said switch capable of controlling volume of electricity flowing through either said first light bulb or said second light bulb or both.

69. The lighting fixture of claim 61, wherein both said first light bulb and said second light bulb can be a plurality of light bulbs.

70. The lighting fixture of claim 61, wherein both said first light bulb housing and said second light bulb housing can be a plurality of light bulb housings.

71. The lighting fixture of claim 61, wherein said pivot connector can be a plurality of pivot connectors.

72. The lighting fixture of claim 61, wherein said mounting base can be a plurality of mounting bases.

73. The lighting fixture of claim 61, wherein said electrical line can be a plurality of electrical lines.

74. The lighting fixture of claim 61 further comprises a transformer, said transformer connected said lighting fixture to said electric power source.

75. A retractable and adjustable multi-purpose indoor lighting fixture capable of providing both ambient surrounding room light and direct illumination for a specific surface area, said lighting fixture comprising:
a first light bulb housing, said first light bulb housing containing a first lighting source;
a second light bulb housing, said second light bulb housing containing a second lighting source;
a pivot connector, said pivot connector connecting said first light bulb housing to said second light bulb housing;
a mounting base, said mounting base connecting said first light bulb housing to a wall or alike; and
an electrical line, said electrical line connecting both said first lighting source and said second lighting source to an electric power source.

76. The lighting fixture of claim 75, wherein said first light bulb housing further comprises a first light bulb housing wall and a first adjustable light bulb housing cover, said first adjustable light bulb housing cover being transparent.

77. The lighting fixture of claim 75, wherein said second light bulb housing further comprises a second light bulb housing wall and a second adjustable light bulb housing cover, said second adjustable light bulb housing cover being transparent.

78. The lighting fixture of claim 75, wherein either said first lighting source or said second lighting source or both further comprises a plurality of lighting sources.

79. The lighting fixture of claim 75, wherein said first lighting source is connected to a first switch, said first switch capable of controlling the volume of electricity flowing through said first lighting source.

80. The lighting fixture of claim 75, wherein said second lighting source is connected to a second switch, said second switch capable of controlling the volume of electricity flowing through said second lighting source.

81. The lighting fixture of claim 75, wherein both said first lighting source and said second lighting source are connected to a switch, said switch capable of controlling the volume of electricity flowing through either said first lighting source or said second lighting source or both.

82. The lighting fixture of claim 75, wherein either said first light bulb housing or said second light bulb housing or both can be a plurality of light bulb housings.

83. The lighting fixture of claim 75, wherein said pivot connector can be a plurality of pivot connectors.

84. The lighting fixture of claim 75, wherein said mounting base can be a plurality of mounting bases.

85. The lighting fixture of claim 75 further comprises a transformer, said transformer connecting either said first lighting source or said second lighting source or both to said electric power source.

86. A retractable and adjustable multi-purpose indoor lighting fixture capable of providing both ambient surrounding room light and direct illumination for a specific surface area, said lighting fixture comprising:
a first lighting source;
a second lighting source connected to said first lighting source through a pivot connector;
an arm set, said arm set having a first arm set end and a second arm set end, said first arm set end connected to said first lighting source, said second arm set end connected to a mounting base; and
an electrical line, said electrical line connecting both said first lighting source and said second lighting source to an electric power source.

87. The lighting fixture of claim 86, wherein said first lighting source further comprises a first lighting source housing.

88. The lighting fixture of claim 86, wherein said second lighting source further comprises a second lighting source housing.

89. The lighting fixture of claim 86, wherein either said first lighting source or said second lighting source or both further comprises a transparent lighting source cover.

90. The lighting fixture of claim 86 further comprises a switch capable of adjusting the volume of electricity flowing through either said first lighting source or said second lighting source or both.

91. The lighting fixture of claim 86, wherein said first lighting source further comprises a plurality of lighting sources.

92. The lighting fixture of claim 86, wherein said second lighting source further comprises a plurality of lighting sources.

93. The lighting fixture of claim 86, wherein said mounting base can be a plurality of mounting bases.

94. The lighting fixture of claim 86, wherein said electrical line can be a plurality of electrical lines.

95. The lighting fixture of claim 86 further comprises a transformer, said transformer connecting either said first lighting source or said second lighting source or both to said electric power source.

96. A retractable and adjustable multi-purpose indoor lighting fixture capable of providing both ambient surrounding room light and direct illumination for a specific surface area, said lighting fixture comprising:
a mounting base;
a first lighting source connected to said mounting base; and
a second lighting source connecting to said first lighting source.

97. The lighting fixture of claim 96 further comprises a switch capable of adjusting the volume of electricity flowing through either said first lighting source or said second lighting source or both.

98. The lighting fixture of claim 96, wherein said first lighting source further comprises a plurality of lighting sources.

99. The lighting fixture of claim 96, wherein said second lighting source further comprises a plurality of lighting sources.

100. The lighting fixture of claim 96 further comprises a transformer.

101. The lighting fixture of claim 96, wherein said first lighting source can be extended out from said mounting base.

102. The lighting fixture of claim 96, wherein said second lighting source can be extended out from said first lighting source.

103. An apparatus for the use of a retractable and adjustable multi-purpose indoor lighting fixture capable of providing both ambient surrounding room light and direct illumination for a specific surface area, said apparatus comprising:
means for installing said retractable and adjustable multi-purpose indoor lighting fixture capable of being both a wall sconce/wall wash light and a reading light, or working light, or picture light, or display light, said lighting fixture having a light bulb housing, a pivot connector, said pivot connector having a first pivot end and a second pivot end, said first pivot end connecting to said light bulb housing, a retractable arm box, said retractable arm box connecting to said second pivot end, a retractable arm set, said retractable arm set having a first retractable arm end and a second retractable arm end, said first retractable arm end connecting to said retractable arm box, a mounting base, said mounting base having a first mounting base end and a second mounting base end, said first mounting base end connecting to said second retractable arm end, and said second mounting base end mounting onto a wall, an electrical line, said electrical line having a first electrical line end and a second electrical line end, said first electrical line end connected with said light bulb, said second electrical line end connected to an electric power source, a switch connecting to said lighting fixture capable of controlling the volume of electricity flowing through said lighting fixture;
means for turning on said switch to use said lighting fixture as said wall sconce/wall wash light; and
means for turning said light bulb housing around said pivot connector;
means for extending out said retractable arm; and
means for converting said wall sconce/wall wash light into said reading light, or working light, or picture light, or display light.

104. The apparatus of claim 103, wherein the means for converting said wall sconce/wall wash light into said reading light, or working light, or picture light, or display light further comprises:
means for turning said light bulb housing clock-wise around said pivot connector; and
means for pulling out said retractable arm set.

105. The apparatus of claim 103, wherein said socket can be a plurality of sockets, each socket having a light bulb.

106. The apparatus of claim 103, wherein either said light bulb or said reflector is adjustable.

107. The apparatus of claim 103, wherein said retractable arm set has a plurality of retractable arms, all of which can be retracted and disposed into said retractable arm box.

108. The apparatus of claim 103, wherein said light bulb housing can be a plurality of light bulb housings.

109. The apparatus of claim 103, wherein said pivot connector can be a plurality of pivot connectors.

110. The apparatus of claim 103, wherein said retractable arm set can be a plurality of retractable arm sets.

111. The apparatus of claim 103, wherein said lighting fixture further comprises a transformer, said transformer connected said lighting fixture to said electric power source.

112. An apparatus for the use of a retractable and adjustable multi-purpose indoor lighting fixture capable of providing both ambient surrounding room light and direct illumination for a specific surface area, said apparatus comprising:
means for installing a mounting base;
means for installing a retractable arm box onto said mounting base, said retractable arm box having a retractable arm set, said retractable arm set having a first retractable arm set end and a second retractable arm set end, said first retractable arm set end connected to said mounting base, said second retractable arm set end connected to said retractable arm box;
means for installing a light bulb housing, said light bulb housing containing a reflector, a socket, a light bulb, said light bulb connected to said socket, said reflector positioned between said light bulb and said light bulb housing, said light bulb housing connecting to said retractable arm box through a pivot connector.

113. The apparatus of claim 112, wherein said light bulb housing capable of being turned around said pivot connector.

114. The apparatus of claim 112, wherein said light bulb housing capable of being extended out from said mounting base by extending out said retractable arm set.

115. The apparatus of claim 112, wherein said socket can be a plurality of sockets, each socket having a lighting source.

116. The apparatus of claim 112, wherein either said light bulb or said reflector is adjustable.

117. The apparatus of claim 112, wherein said retractable arm set has a plurality of retractable arms, all of which can be retracted and deposited into said retractable arm box.

118. The apparatus of claim 112, wherein said light bulb housing can be a plurality of light bulb housings.

119. The apparatus of claim 112, wherein said pivot connector can be a plurality of pivot connectors.

120. The apparatus of claim 112, wherein said retractable arm set can be a plurality of retractable arm sets.

121. The apparatus of claim 112, wherein said lighting fixture further comprises a transformer, said transformer connected said lighting fixture to said electric power source.

122. An apparatus for the use of a retractable and adjustable multi-purpose indoor lighting fixture capable of providing both ambient surrounding room light and direct illumination for a specific surface area, said apparatus comprising:
means for installing a mounting base;
means for installing a mounting arm, said mounting arm having a first mounting arm end and a second mounting arm end, said first mounting arm end connecting to said mounting base;
means for installing a first light bulb housing, said first light bulb housing having a first light bulb housing arm, said first light bulb housing arm connected to said second mount arm end, said first light bulb housing further comprising a first back light bulb housing cover, a first light bulb housing wall, a first glass front light bulb housing cover, a first socket, said first socket connected to said first light bulb housing wall, a first light bulb, said first light bulb connected to said first socket and positioned between said first back light bulb housing cover and said first glass front light bulb housing cover, a first reflector, said first reflector connected to said first light bulb housing wall and positioned between said first back light bulb housing cover and said first light bulb; and
means for installing a second light bulb housing, said second light bulb housing having a second light bulb housing arm, said second light bulb housing arm connected to said first light bulb housing arm through a pivot connector, said second light bulb housing further comprising a second back light bulb housing cover, a second light bulb housing wall, a second glass front light bulb housing cover, a second socket, said second socket connected to said second light bulb housing wall, a second light bulb, said second light bulb connected to said second socket and positioned between said second back light bulb housing cover and said second glass front light bulb housing cover, a second reflector, said second reflector connected to said second light bulb housing wall and positioned between said second back light bulb housing cover and said second light bulb.

123. The apparatus of claim 122, wherein said second light bulb housing capable of being turned around said pivot connector.

124. The apparatus of claim 122, wherein said first socket can be a plurality of first sockets, each of which having a first light bulb.

125. The apparatus of claim 122, wherein said second socket can be a plurality of second sockets, each of which having a second light bulb.

126. The apparatus of claim 122, wherein the light beam angle of either said first light bulb or said second light bulb or both are adjustable.

127. The apparatus of claim 122, wherein said first light bulb is connected to a first switch, said first switch capable of controlling volume of electricity flowing through said first light bulb.

128. The apparatus of claim 122, wherein said second light bulb is connected to a second switch, said second switch capable of controlling volume of electricity flowing through said second light bulb.

129. The apparatus of claim 122, wherein said first switch and said second switch can be the same switch.

130. The apparatus of claim 122, wherein said first light bulb housing can be a plurality of first light bulb housings.

131. The apparatus of claim 122, wherein said second light bulb housing can be a plurality of second light bulb housings.

132. The apparatus of claim 122, wherein said pivot connector can be a plurality of pivot connectors.

133. The apparatus of claim 122, wherein said mounting base can be a plurality of mounting bases.

134. The apparatus of claim 122, wherein said lighting fixture further comprises a transformer, said transformer connecting both said first light bulb and said second light bulb to an electric power source.

135. A retractable and adjustable multi-purpose indoor lighting fixture capable of providing both ambient surrounding room light and direct illumination for a specific surface area, said lighting fixture comprising:
a lighting source;
a base;
an arm set, said arm set connecting said lighting source to said base;
an electrical line, said electrical line connecting said lighting source to an electric power source; and
a switch, said switch connected to said electrical line.

136. The lighting fixture of claim 135 further comprises a transformer, said transformer connecting said lighting source to said electric power source.

137. The lighting fixture of claim 136, wherein said lighting source can be a plurality of lighting sources, each of which is independent to each other.

138. The lighting fixture of claim 137, wherein each of said plurality of lighting sources is deposited within a lighting source housing, said lighting source housing connected to said arm set.

139. The lighting fixture of claim 138, wherein said arm set is adjustable to position each of said plurality of lighting sources to different positions to enable said lighting fixture to light different area with different strength of light.

140. The lighting fixture of claim 139, wherein the volume of electricity passing through each of said plurality of lighting sources could be adjusted by said switch.

141. The lighting fixture of claim 140, wherein said switch could be controlled either directly or remotely by a remote control sensor.

142. The lighting fixture of claim 141, wherein said remote control sensor is capable of respondent to various signals received by said remote control sensor in controlling said switch.
